(19) United States
(12) Patent Application Publication
(10) Pub. No.: US 2007/0112854 A1
(43) Pub. Date: May 17, 2007

(54) Apparatus and method for automatic generation and distribution of documents

(76) Inventor: Paulo Bianchi Franca, Cupertino, CA (US)

Correspondence Address: MICHAEL W. CALDWELL, 4226 RIVERMARK PARKWAY, SANTA CLARA, CA, 95054-4150, US

(21) Appl. No.: 11/273,486

(22) Filed: Nov. 12, 2005

(51) Int. Cl. G06F 17/00

(52) U.S. Cl. 707/104.1

(57) ABSTRACT

A computerized method for the automatic generation and distribution of documents is disclosed. A database is maintained by a computer. The database includes a list of the information required to complete a document associated with a case, and further includes a list of intended recipients, the contact information associated with each recipient, and the distribution method(s) preferred by each recipient. When all required information for a given document is available the document is automatically generated, then automatically sent to each recipient via the recipient's requested distribution method(s) without any further action by the system user.

### COMPUTER PROGRAM LISTING APPENDIX

The computer program listing appendix attached hereto consists of two (2) identical compact disks, copy 1 and copy 2, each containing a listing of the software code for one embodiment of the components of this invention. Each compact disk contains the following files (date of creation, size in bytes, file name):

| | | |
|---|---|---|
| Nov. 11, 2005 | 18,345 | \includecm\draft3.php4 |
| Nov. 11, 2005 | 55,438 | \includecm\draftfunctions.php4 |
| Nov. 11, 2005 | 22,151 | \includecm\draftprocess.php4 |
| Nov. 11, 2005 | 376 | \includecm\start.php4 |
| Nov. 11, 2005 | 3,939 | \includecm\start2.php4 |
| Nov. 11, 2005 | 376 | \includecm\startold.php4 |
| Nov. 11, 2005 | 17,320 | \includecm\doc-safe\no_transfer.php4 |
| Nov. 11, 2005 | 17,268 | \includecm\doc-safe\transfer.php4 |
| Nov. 11, 2005 | 11,531 | \includecm\programs\config.php4 |
| Nov. 11, 2005 | 79,301 | \includecm\programs\contact.php4 |
| Nov. 11, 2005 | 1,010 | \includecm\programs\crypt.php4 |
| Nov. 11, 2005 | 3,313 | \includecm\programs\date.php4 |
| Nov. 11, 2005 | 15,050 | \includecm\programs\dbclass.php4 |
| Nov. 11, 2005 | 665 | \includecm\programs\delete_temp_faxfiles.php4 |
| Nov. 11, 2005 | 717 | \includecm\programs\deleteoldpdfs.php4 |
| Nov. 11, 2005 | 3,902 | \includecm\programs\displaynotes.php4 |
| Nov. 11, 2005 | 4,399 | \includecm\programs\doc_conversion.php4 |
| Nov. 11, 2005 | 20,445 | \includecm\programs\docgen.php4 |
| Nov. 11, 2005 | 1,275 | \includecm\programs\dropdownmenu.php4 |
| Nov. 11, 2005 | 1,414 | \includecm\programs\event.php4 |
| Nov. 11, 2005 | 26,840 | \includecm\programs\fax.php4 |
| Nov. 11, 2005 | 15,246 | \includecm\programs\faxfunctions.php4 |
| Nov. 11, 2005 | 1,750 | \includecm\programs\feedbacknotify.php4 |
| Nov. 11, 2005 | 2,061 | \includecm\programs\firstinclude.php4 |
| Nov. 11, 2005 | 11,675 | \includecm\programs\formchek.php4 |
| Nov. 11, 2005 | 3,483 | \includecm\programs\functions.h |
| Nov. 11, 2005 | 54,248 | \includecm\programs\html.php4 |
| Nov. 11, 2005 | 5,852 | \includecm\programs\imaging.php4 |
| Nov. 11, 2005 | 7,616 | \includecm\programs\letter.php4 |
| Nov. 11, 2005 | 1,444 | \includecm\programs\locations.php4 |
| Nov. 11, 2005 | 11,637 | \includecm\programs\mail.php4 |
| Nov. 11, 2005 | 46,413 | \includecm\programs\misc.php4 |
| Nov. 11, 2005 | 6,047 | \includecm\programs\nursemenus.php4 |
| Nov. 11, 2005 | 10,191 | \includecm\programs\paperkeep.php4 |
| Nov. 11, 2005 | 5,036 | \includecm\programs\popupchecks.php4 |
| Nov. 11, 2005 | 1,875 | \includecm\programs\printdebug.php4 |
| Nov. 11, 2005 | 1,764 | \includecm\programs\qanotify.php4 |
| Nov. 11, 2005 | 4,926 | \includecm\programs\query.php4 |
| Nov. 11, 2005 | 19,043 | \includecm\programs\redform.php4 |
| Nov. 11, 2005 | 2,953 | \includecm\programs\relation.php4 |
| Nov. 11, 2005 | 3,899 | \includecm\programs\snailmail.php4 |
| Nov. 11, 2005 | 2,312 | \includecm\programs\spellcheck.php4 |
| Nov. 11, 2005 | 873 | \includecm\programs\startpage.php4 |
| Nov. 11, 2005 | 7,871 | \includecm\programs\stats.php4 |
| Nov. 11, 2005 | 8,460 | \includecm\programs\tabclass.h |
| Nov. 11, 2005 | 28,850 | \includecm\programs\templatebuilder.php4 |
| Nov. 11, 2005 | 1,346 | \includecm\programs\timer.php4 |
| Nov. 11, 2005 | 12,217 | \includecm\programs\transcript.php4 |
| Nov. 11, 2005 | 2,019 | \includecm\programs\transcriptdocsafe.php4 |
| Nov. 11, 2005 | 1,757 | \includecm\programs\transcriptftp.php4 |
| Nov. 11, 2005 | 2,046 | \includecm\programs\transcriptnotify.php4 |
| Nov. 11, 2005 | 2,832 | \includecm\programs\uploaddir.php4 |
| Nov. 11, 2005 | 2,371 | \includecm\programs\user.php4 |
| Nov. 11, 2005 | 22,793 | \includecm\programs\faxmail\fax.php4 |
| Nov. 11, 2005 | 20,249 | \includecm\programs\faxmail\faxmail.php4 |
| Nov. 11, 2005 | 4,415 | \includecm\protected\draft.php4 |
| Nov. 11, 2005 | 18,623 | \includecm\protected\draft3.php4 |
| Nov. 11, 2005 | 2,106 | \includecm\protected\draftbackauthor.php4 |
| Nov. 11, 2005 | 2,110 | \includecm\protected\draftcheck.php4 |
| Nov. 11, 2005 | 5,648 | \includecm\protected\draftcheckall.php4 |
| Nov. 11, 2005 | 49,819 | \includecm\protected\draftfunctions.php4 |
| Nov. 11, 2005 | 3,568 | \includecm\protected\drafthelp.php4 |
| Nov. 11, 2005 | 1,480 | \includecm\protected\draftnotes.php4 |
| Nov. 11, 2005 | 22,495 | \includecm\protected\draftprocess.php4 |
| Nov. 11, 2005 | 233 | \includecm\protected\draftproof.php4 |
| Nov. 11, 2005 | 2,975 | \includecm\protected\draftproofselect.php4 |
| Nov. 11, 2005 | 3,571 | \includecm\protected\draftsummary.php4 |
| Nov. 11, 2005 | 2,655 | \includecm\protected\draftupload.php4 |
| Nov. 11, 2005 | 26,382 | \includecm\protected\index.php4 |
| Nov. 11, 2005 | 6,814 | \includecm\protected\letter.php4 |
| Nov. 11, 2005 | 3,628 | \includecm\protected\list.php4 |
| Nov. 11, 2005 | 6,282 | \includecm\protected\passwd.php4 |
| Nov. 11, 2005 | 1,362 | \includecm\protected\passwdupdate.php4 |
| Nov. 11, 2005 | 4,146 | \includecm\protected\queryproc.php4 |
| Nov. 11, 2005 | 3,355 | \includecm\protected\queryreports.php4 |
| Nov. 11, 2005 | 2,070 | \includecm\protected\report.php4 |
| Nov. 11, 2005 | 3,039 | \includecm\protected\reportinfo.php4 |
| Nov. 11, 2005 | 1,538 | \includecm\protected\reportrename.php4 |
| Nov. 11, 2005 | 5,855 | \includecm\protected\reportroster.php4 |
| Nov. 11, 2005 | 2,172 | \includecm\protected\reportupdate.php4 |
| Nov. 11, 2005 | 2,132 | \includecm\protected\reportupload.php4 |
| Nov. 11, 2005 | 6,674 | \includecm\protected\reportuploadroster.php4 |
| Nov. 11, 2005 | 4,114 | \includecm\protected\reportuploadupdate.php4 |
| Nov. 11, 2005 | 938 | \includecm\protected\spec.php4 |
| Nov. 11, 2005 | 1,781 | \includecm\protected\specroster.php4 |
| Nov. 11, 2005 | 1,346 | \includecm\protected\specupdate.php4 |
| Nov. 11, 2005 | 5,163 | \includecm\protected\spellcheckupdate.php4 |
| Nov. 11, 2005 | 2,487 | \includecm\protected\tempcontacts.php4 |
| Nov. 11, 2005 | 2,486 | \includecm\protected\upsig.php4 |
| Nov. 11, 2005 | 869 | \includecm\protected\useful.php4 |
| Nov. 11, 2005 | 6,050 | \includecm\protected\writeletter.php4 |
| Nov. 11, 2005 | 13,839 | \includecm\protected\draft\newpdf.php4 |
| Nov. 11, 2005 | 1,403 | \includecm\protected\draft\recover.php4 |
| Nov. 11, 2005 | 2,223 | \includecm\protected\draft\restore.php4 |
| Nov. 11, 2005 | 1,618 | \includecm\protected\draft\view.php4 |
| Nov. 11, 2005 | 2,270 | \includecm\protected\draft\template\choose.php4 |
| Nov. 11, 2005 | 3,986 | \includecm\protected\draft\template\drafthelp.htm |
| Nov. 11, 2005 | 1,462 | \includecm\protected\draft\template\enter.htm |
| Nov. 11, 2005 | 4,836 | \includecm\protected\draft\template\enter.php4 |
| Nov. 11, 2005 | 1,933 | \includecm\protected\draft\template\maketemplate.php4 |
| Nov. 11, 2005 | 5,676 | \includecm\protected\draft\template\modspecs.php4 |
| Nov. 11, 2005 | 2,683 | \includecm\protected\draft\template\preview.php4 |
| Nov. 11, 2005 | 8,541 | \includecm\protected\forms\buildpdf.php4 |
| Nov. 11, 2005 | 7,477 | \includecm\protected\forms\managetemplates.php4 |
| Nov. 11, 2005 | 8,809 | \includecm\protected\medicalchart\medicalchart.htm |
| Nov. 11, 2005 | 32,725 | \includecm\protected\medicalchart\medicalchart.php4 |
| Nov. 11, 2005 | 2,700 | \includecm\protected\paperkeep\deletefile.php4 |
| Nov. 11, 2005 | 2,320 | \includecm\protected\paperkeep\deletefileupdate.php4 |
| Nov. 11, 2005 | 7,006 | \includecm\protected\paperkeep\docsearch.php4 |
| Nov. 11, 2005 | 3,137 | \includecm\protected\paperkeep\faxrouter.php4 |
| Nov. 11, 2005 | 973 | \includecm\protected\paperkeep\fileid.php4 |
| Nov. 11, 2005 | 3,473 | \includecm\protected\paperkeep\filerouter.php4 |
| Nov. 11, 2005 | 6,228 | \includecm\protected\paperkeep\filetransfer.php4 |
| Nov. 11, 2005 | 2,608 | \includecm\protected\paperkeep\fixbillboard.php4 |
| Nov. 11, 2005 | 3,104 | \includecm\protected\paperkeep\fixdescription.php4 |
| Nov. 11, 2005 | 6,677 | \includecm\protected\paperkeep\help.php4 |
| Nov. 11, 2005 | 11,476 | \includecm\protected\paperkeep\listall.php4 |
| Nov. 11, 2005 | 2,748 | \includecm\protected\paperkeep\listbillboard.php4 |
| Nov. 11, 2005 | 25,373 | \includecm\protected\paperkeep\listbillboardnew.php4 |
| Nov. 11, 2005 | 27,092 | \includecm\protected\paperkeep\listbillboardold.php4 |
| Nov. 11, 2005 | 5,236 | \includecm\protected\paperkeep\listtranscripts.php4 |
| Nov. 11, 2005 | 1,415 | \includecm\protected\paperkeep\mailfile.php4 |
| Nov. 11, 2005 | 2,691 | \includecm\protected\paperkeep\pdf2jpegview.php4 |
| Nov. 11, 2005 | 6,820 | \includecm\protected\paperkeep\routeselector.php4 |
| Nov. 11, 2005 | 2,396 | \includecm\protected\paperkeep\testcommunity.php4 |
| Nov. 11, 2005 | 2,116 | \includecm\protected\paperkeep\track.php4 |
| Nov. 11, 2005 | 10,692 | \includecm\protected\paperkeep\upcommunity.php4 |
| Nov. 11, 2005 | 1,009 | \includecm\protected\paperkeep\updescription.php4 |
| Nov. 11, 2005 | 8,446 | \includecm\protected\paperkeep\upmailbox.php4 |
| Nov. 11, 2005 | 4,003 | \includecm\protected\paperkeep\upmemos.php4 |
| Nov. 11, 2005 | 5,277 | \includecm\protected\paperkeep\uprecord.php4 |
| Nov. 11, 2005 | 4,208 | \includecm\protected\paperkeep\uptranscript.php4 |
| Nov. 11, 2005 | 2,349 | \includecm\protected\paperkeep\uptranscriptupdate.php4 |
| Nov. 11, 2005 | 1,852 | \includecm\protected\snailmail\coveranddoc.php4 |
| Nov. 11, 2005 | 13,622 | \includecm\protected\snailmail\coversheet.php4 |
| Nov. 11, 2005 | 877 | \includecm\protected\snailmail\deleteletters.php4 |
| Nov. 11, 2005 | 3,281 | \includecm\protected\snailmail\makecertified.php4 |
| Nov. 11, 2005 | 2,215 | \includecm\protected\snailmail\sc-create.php4 |
| Nov. 11, 2005 | 8,250 | \includecm\protected\snailmail\searchform.php4 |
| Nov. 11, 2005 | 23,787 | \includecm\protected\snailmail\snailmailfunctions.php4 |
| Nov. 11, 2005 | 549 | \includecm\protected\snailmail\snailmailqueue.php4 |
| Nov. 11, 2005 | 535 | \includecm\protected\snailmail\snailmailqueuelog.php4 |
| Nov. 11, 2005 | 1,062 | \includecm\protected\snailmail\certified\snailmailcertified.php4 |
| Nov. 11, 2005 | 5,336 | \includecm\protected\sortbox\file_status.php4 |
| Nov. 11, 2005 | 3,360 | \includecm\protected\sortbox\scan_intake.php4 |
| Nov. 11, 2005 | 1,787 | \includecm\protected\sortbox\selectoldcase.php4 |
| Nov. 11, 2005 | 30,615 | \includecm\protected\sortbox\sortbox.php4 |
| Nov. 11, 2005 | 1,437 | \includecm\protected\sortbox\transferfile.php4 |
| Nov. 11, 2005 | 7,514 | \includecm\protected\urtemplates\addendumhtm.php4 |
| Nov. 11, 2005 | 6,638 | \includecm\protected\urtemplates\addendummdhtm.php4 |
| Nov. 11, 2005 | 10,322 | \includecm\protected\urtemplates\alt_urproof.php4 |
| Nov. 11, 2005 | 13,150 | \includecm\protected\urtemplates\bak.urproof.php4 |
| Nov. 11, 2005 | 10,680 | \includecm\protected\urtemplates\bak.urreviewerhtm.php4 |
| Nov. 11, 2005 | 2,118 | \includecm\protected\urtemplates\changemanager.php4 |
| Nov. 11, 2005 | 3,277 | \includecm\protected\urtemplates\changereportstatus.php4 |
| Nov. 11, 2005 | 4,429 | \includecm\protected\urtemplates\changes.php4 |
| Nov. 11, 2005 | 3,096 | \includecm\protected\urtemplates\changeservice.php4 |
| Nov. 11, 2005 | 7,041 | \includecm\protected\urtemplates\confirm.php4 |
| Nov. 11, 2005 | 11,371 | \includecm\protected\urtemplates\Copy of urnursehtm.php4 |
| Nov. 11, 2005 | 19,978 | \includecm\protected\urtemplates\distribute.php4 |
| Nov. 11, 2005 | 10,008 | \includecm\protected\urtemplates\eletter.php4 |
| Nov. 11, 2005 | 8,158 | \includecm\protected\urtemplates\guestletter.php4 |
| Nov. 11, 2005 | 10,630 | \includecm\protected\urtemplates\letterbuilder.php4 |
| Nov. 11, 2005 | 9,977 | \includecm\protected\urtemplates\macrofunctions.php4 |
| Nov. 11, 2005 | 6,087 | \includecm\protected\urtemplates\mdoldreview.php4 |
| Nov. 11, 2005 | 1,717 | \includecm\protected\urtemplates\miscfunctions.php4 |
| Nov. 11, 2005 | 1,712 | \includecm\protected\urtemplates\oldissues.php4 |
| Nov. 11, 2005 | 11,041 | \includecm\protected\urtemplates\quickletter.php4 |
| Nov. 11, 2005 | 22,952 | \includecm\protected\urtemplates\reportbuilder.php4 |
| Nov. 11, 2005 | 3,392 | \includecm\protected\urtemplates\save.php4 |
| Nov. 11, 2005 | 9,633 | \includecm\protected\urtemplates\selectionform.php4 |
| Nov. 11, 2005 | 19,730 | \includecm\protected\urtemplates\sendreview.php4 |
| Nov. 11, 2005 | 1,099 | \includecm\protected\urtemplates\showassessment.php4 |
| Nov. 11, 2005 | 1,836 | \includecm\protected\urtemplates\staffinfo.php4 |
| Nov. 11, 2005 | 1,325 | \includecm\protected\urtemplates\testbinsearch.php4 |
| Nov. 11, 2005 | 5,358 | \includecm\protected\urtemplates\urclose.php4 |
| Nov. 11, 2005 | 43,628 | \includecm\protected\urtemplates\urfunctions.php4 |
| Nov. 11, 2005 | 1,846 | \includecm\protected\urtemplates\urhistory.php4 |
| Nov. 11, 2005 | 11,344 | \includecm\protected\urtemplates\urnurse.php4 |
| Nov. 11, 2005 | 9,763 | \includecm\protected\urtemplates\urnursehtm.php4 |
| Nov. 11, 2005 | 8,635 | \includecm\protected\urtemplates\urphysicianhtm.php4 |
| Nov. 11, 2005 | 13,906 | \includecm\protected\urtemplates\urproof.php4 |
| Nov. 11, 2005 | 4,903 | \includecm\protected\urtemplates\urreviewer.php4 |
| Nov. 11, 2005 | 11,702 | \includecm\protected\urtemplates\urreviewerhtm.php4 |
| Nov. 11, 2005 | 1,641 | \includecm\protected\utilization\confirmdeletefile.php4 |
| Nov. 11, 2005 | 1,250 | \includecm\protected\utilization\deletefile.php4 |
| Nov. 11, 2005 | 2,816 | \includecm\protected\utilization\index.php4 |
| Nov. 11, 2005 | 4,982 | \includecm\protected\utilization\list1.php4 |
| Nov. 11, 2005 | 4,912 | \includecm\protected\utilization\search.php4 |
| Nov. 11, 2005 | 5,168 | \includecm\protected\utilization\searchur.php4 |
| Nov. 11, 2005 | 6,020 | \includecm\protected\utilization\updateur.php4 |
| Nov. 11, 2005 | 4,621 | \includecm\protected\utilization\uploadform.php4 |
| Nov. 11, 2005 | 2,615 | \includecm\protected\utilization\uploadurfile.php4 |
| Nov. 11, 2005 | 3,343 | \includecm\protected\utilization\urclass.php4 |
| Nov. 11, 2005 | 7,911 | \includecm\protected\utilization\urfilelist.php4 |
| Nov. 11, 2005 | 7,403 | \includecm\protected\utilization\urroster.php4 |
| Nov. 11, 2005 | 3,013 | \includecm\protected\utilization\utilization.php4 |
| Nov. 11, 2005 | 6,320 | \includecm\protected\utilization\utilizationreview.php4 |
| Nov. 11, 2005 | 6,912 | \includecm\protected\utilization\utilizationroster.php4 |
| Nov. 11, 2005 | 7,195 | \includecm\protected\utilization\viewur.php4 |
| Nov. 11, 2005 | 7,798 | \includecm\protected\utilization\viewurdetail.php4 |
| Nov. 11, 2005 | 832 | \includecm\protected\utilization\viewurfile.php4 |
| Nov. 11, 2005 | 30,262 | \includeur\protected\nursecases.php4 |
| Nov. 11, 2005 | 21,954 | \includeur\protected\shortlist.php4 |

Total number of files = 204
Sum of file sizes = 1,685,194 Bytes

The contents of the compact disk are a part of the present disclosure, and are incorporated by reference herein in their entireties.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention is related to office automation. More specifically, it is related to the generation and distribution of documents.

### BACKGROUND OF THE INVENTION

In a modern office environment wherein documents concerning various aspects of a wide range of subjects are created or received, it is often important for the documents to be sent to other individuals or agencies in a timely manner. Furthermore, it may be just as important that a document not be provided to certain entities. In addition, a certain subset of the total information received or available may be appropriate for some recipients and not others. Email and physical mailing lists and facsimile group numbers are often used for distribution, but determining which distribution means is preferred by which recipient as well as determining which document goes to which recipient has proven to be very time consuming, labor intensive, and error prone.

### SUMMARY OF THE INVENTION

The present invention comprises a computer-based system for managing documents. It uses software which creates and is responsive to database information. The database includes such basic information as the name, address, phone number and such of a subject as well as that of others associated with the project at hand. For example, the subject may be a health care patient, and those associated with the patient may include a physician, an insurance carrier, an attorney, a therapist, and the like. One of those associated with the patient may be known to prefer to receive patient related documents via fax with a hard copy by physical mail while another prefers all documents as attachments to an email. The method of the present invention provides for a user, which may be a physician, nurse, office administrator and the like, to create a document assisted by the system, then automatically distribute the document as an attachment to an email, as a fax, or by physical mail to include any one, two, or three of these methods. This information, having been pre-positioned, including indicators of which potential recipient should receive which certain type of document and by what method(s), eliminates the need for the user to even know to whom a document should be sent, yet alone have to find the appropriate contact information for each method.

When a document is created, reviewed, and released for distribution using a terminal associated with the system, it is sent to a mass storage means for archiving. The system then looks to a database associated with a certain project for a certain subject and generates one or more versions of the document, each as an image file, then further accesses the database to distribute the document in its various versions to all required recipients via their selected one or more methods.

### BRIEF DESCRIPTION OF THE DRAWINGS

FIG. 1 explains the fields of the CASES database.

FIG. 2 explains the fields of the MEDREPORTS database.

FIG. 3 explains the fields of the MEDREPORTTRACK database.

FIG. 4 explains the fields of the ADJUSTORS database.

FIG. 5 explains the fields of the DOCTORS database which differ from that of the ADJUSTORS database.

FIG. 6 explains the fields of the ATTORNEY database which differ from that of the ADJUSTORS database.

FIG. 7 explains the fields of the NURSES database.

FIG. 8 explains the fields of the CARRIERS database.

FIG. 9 explains the fields of the REPORTTEMPLATE database.

FIG. 10 explains the fields of the DOC_SAFE database.

FIG. 11 is an example of evaluating variables using multiple related database tables.

FIG. 12 is an example of a document template.

FIG. 13 explains the fields of the TEMPLATESPECS database.

FIG. 14 is an example of a MASTERDOCUMENT template.

FIG. 15 is an example of a MASTERDOCUMENT created using the template of FIG. 14.

FIG. 16 is an example of a template for a letter to a patient.

FIG. 17 shows a typical computerized system for practicing the present invention.

FIG. 18 is a flow chart illustrating the use of templates in generating documents.

FIG. 19 is an example of a screen presented to a user of the inventive method.

FIG. 20 is an example of a screen presented to a user of the inventive method.

FIG. 21 is an example of a screen presented to a user of the inventive method.

FIG. 22 is an example of a screen presented to a user of the inventive method.

FIG. 23 explains the fields of the FIXSERVE database.

FIG. 24 explains the fields of the TEMPLATECHOICE database.

FIG. 25 is an example of a written document.

### DETAILED DESCRIPTION OF THE INVENTION

Section 1 - DEFINITION OF TERMS AND ANNOTATIONS

| | |
|---|---|
| PC | Personal computer. |
| LAN | Local area network. |
| ISP | Internet service provider. |
| FAX | Facsimile machine or document. |
| SERVER | Stand alone computer or a host/server in a distributed system. |

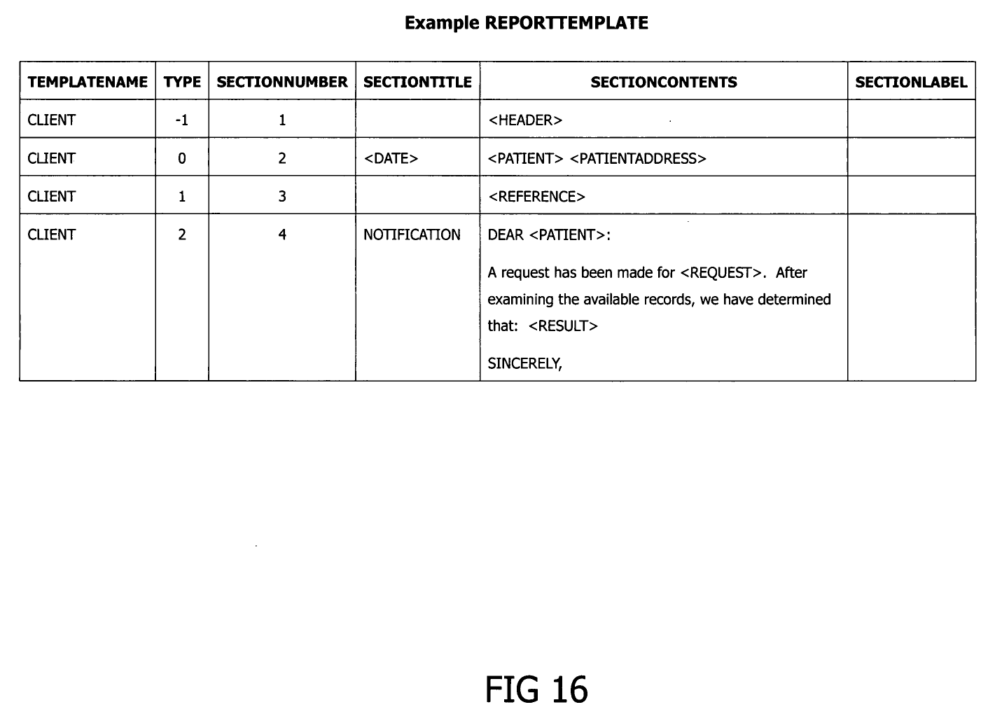

Referring to FIG. 17, the apparatus of the invention 1700 comprises a server 1704 which executes a program and communicates with a mass storage means 1706. In some embodiments the mass storage means is physically encased with the computer. The server may communicate with a printer 1708. The printer prints documents which are to be distributed by physical mail, and may further be used for management documents and such. One or more user terminals 1702 communicates with the server, by means including the industry standards such as USB, RS232, wifi, Bluetooth, LAN and the like. Terminal 1710 is an example of an optional user terminal communicating with the server via an internet connection. A fax machine 1712 is used for sending facsimile documents. In one embodiment the fax machine is a fax/modem internal to the server 1704. An ISP connection provides for the sending and receiving of email. The computer program may be stored on a hard drive, an optical disc, a floppy-disc, or electronic memory. The computer program may be installed on the system of the computer by or computer-readable media such as hard drive, an optical disc, a floppy-disc, or electronic memory or may be provided via a data connection with a server or other outside means of transporting a computer program into the computer. The elements of FIG. 17 may be combined. For example, in one embodiment a stand alone PC with an attached monitor, internal hard drive, internal fax/modem, and a LAN card incorporates 1704, 1702, 1712, and 1706. Any such combination or subcombination may be used to practice the invention.

Throughout this disclosure the annotation DATABASE:FIELD will be used to reference a certain FIELD in a certain database table DATABASE when the reference might otherwise not be clear. Images, such as a complete document including letterhead or a simple text listing, are saved in an image file format. Any image file format may be used, such as an Adobe Systems Portable Document File format, usually referred to as simply a “PDF file”, an AutoDesk Autocad format (“.DXF”), an industry standard JPG or JPEG format, a GIF format, or the like. Data may also be stored for later use in a Comma Separated Values (“.CSV”) file for importing into a spreadsheet or word processor. In one embodiment data is stored in a file format compatible with the Microsoft Excel (“.XLS”) file format. Those familiar with the pertinent art will know of many other suitable file formats.

The “subject” of the system and method of the present invention may be any subject wherein documents are generated, received, or distributed. For example, in one embodiment the subject matter is related to real estate, wherein documents such as an offering contract, loan application, appraisal, rental revenue and such are distributed to a listing agent, a selling agent, a lending institution, a seller, etc, automatically. In another embodiment the subject matter is related to the management of the rehabilitation of an injured worker in the context of Workman's Compensation, distributing documents and authorizations between the parties involved. Other applications will be obvious to those skilled in the art. The specification of this application is detailed in the context of a Workman's Compensation case by way of example, but is not intended to limit the practice of the invention to only that subject matter.

The term “document” is used in describing an object of distribution in practicing the invention. However in some embodiments the object of distribution is a photograph, X-ray image, CAT scan image, audio recording, video recording, website URL; any object which conveys information to the recipient.

### Section 2—Description of Database Tables

The invention includes several database tables, organized into a system for the automatic creation, storage, monitoring, and distribution of documents. These database tables comprise:

CASES Holds the static information for each case. An individual may have more than one case; a case is pertinent to only one person.

MEDREPORTS Holds all document data. Printed documents or document images are generated from this database by the REPORTBUILDER computer program module.

MEDREPORTTRACK Holds the status and history of all documents.

ADJUSTORS Contact information and preferred distribution method(s) for insurance adjustors.

DOCTORSContact information and preferred distribution method(s) for all doctors, other than those employed by the system user.

ATTORNEY Contact information and preferred distribution method(s) for all attorneys in the database, whether a defense attorney or a patient's attorney.

NURSES Contact and other pertinent information for employees of the system user, wherein employees are those who will use or be managed by the system. This includes doctors.

CARRIERS Contact information and preferred distribution method(s) for insurance carriers.

REPORTTEMPLATE Contains prepositioned/default information which is initially placed into a document for review and editing.

DOC_SAFE Tracks the location of all files stored in the mass storage means.+

TEMPLATESPECS Distribution instructions for a non-standard document or letter.

FIXSERVICE Relates alternative spelling or abbreviation of a service to a standardized spelling. Also specifies when first and repeating documents associated with the instant service type are due.

TEMPLATECHOICE Allows for generating a non-standard document specific to a certain CARRIER, OUTCOME, SERVICETYPE, or combination of a plurality of these.

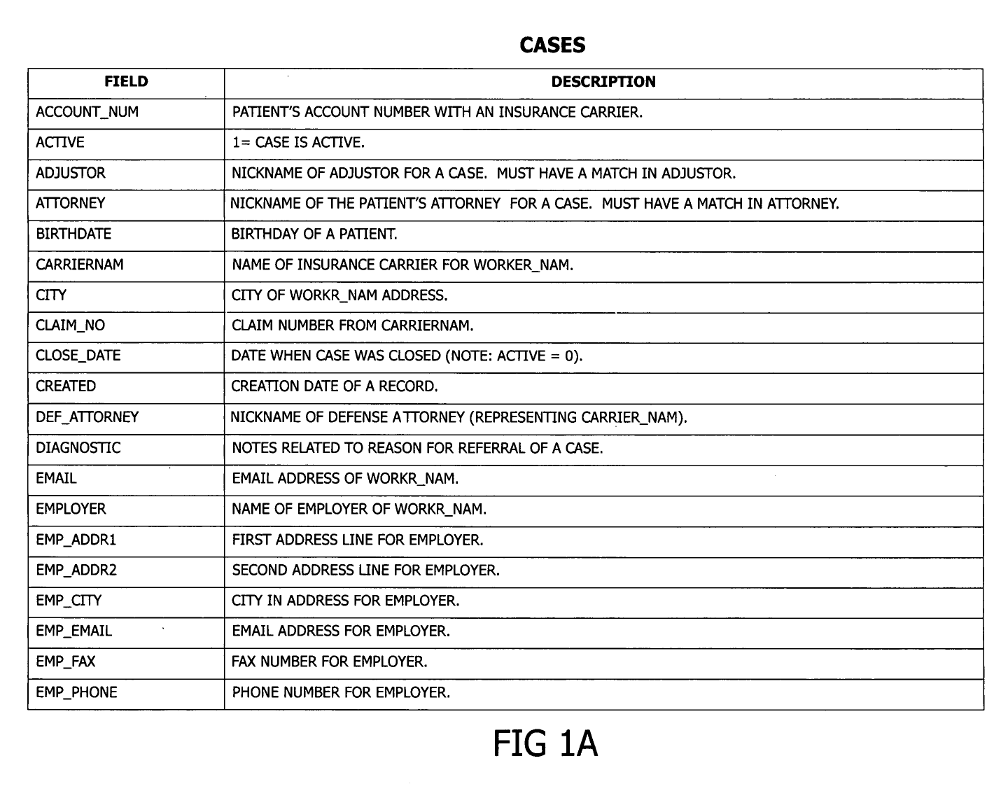

Referring to FIG. 1, data in the CASES database includes all information needed concerning a patient, who is identified by a unique identifier CASEID. Examples include address, employer, attorney, insurance carrier, and the like. The data is static. That is, the data is kept current and used to generate documents, but does not have a historical trail. For example, assume a first document which includes the name of a patient's case manager is generated. A first MANAGER value is captured in MEDREPORTS. If the patient later changes to a second case manager, the name of the second case manager is entered in MANAGER, and the first case manager's name is simply overwritten. Now assume a second document is generated, and the second MANAGER value is used for the second document. The first document was previously stored and does not change, thus still references the first case manager's name, therefore allowing an accurate copy of the first document to be retrieved even though MANAGER in CASES has been changed to the name of the second case manager. This same method might apply for ADJUSTOR, ATTORNEY, SERV_TYPE; that is, CASES data is current at the moment a document is generated, and such data is captured in the instant document but later changed without affecting previously generated documents.

WORKR_ID is associated with a patient for only one CASEID instance. If a patient were to be treated for an additional case, with an additional CASEID, the patient would be assigned an additional WORKR_ID. In some embodiments only one of CASEID or WORKR_ID is used for all tracking.

Examples of SERV_TYPE include “Evaluation”, “Surgery”, “Physical Therapy”, and the like. This is unformatted text, not restricted as to content. As described previously by the example for MANAGER, the contents of the SERV_TYPE field may change as a case progresses, and its value at the time a document is generated is captured by MEDREPORTTRACK. All fields of the CASES database are defined in FIG. 1.

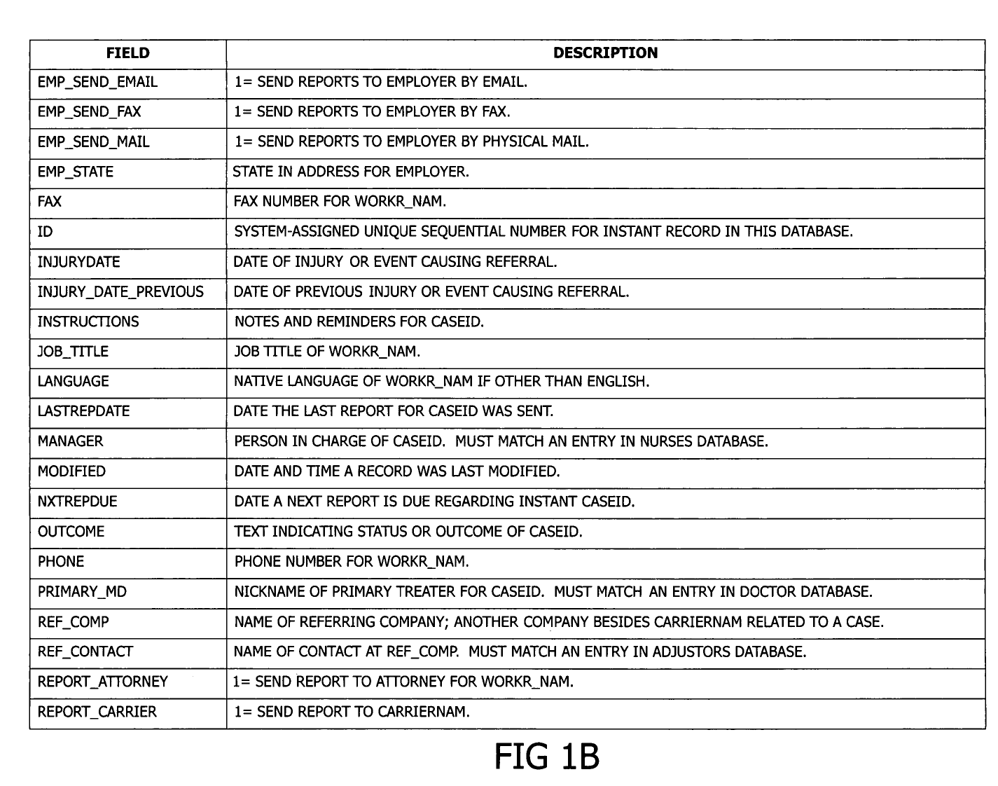

Documents are stored in a database table named “MEDREPORTS”, as shown in FIG. 2. Each record represents one section of one document. All sections with the same CASEID and REPORTNUMBER are uniquely and sequentially numbered (SECTIONNUMBER), starting from one (1), which is always the header section. If a section is inserted or deleted, the remaining sections are renumbered. Throughout this specification we use the term “MASTERDOCUMENT” to mean an extraction of all records with a common CASEID and REPORTNUMBER. That is, there is no stand alone file of a single MASTERDOCUMENT (other than a listing). Thus MEDREPORTS is a superset of all individual MASTERDOCUMENTs. An image of an individual MASTERDOCUMENT is created by a utility “REPORTBUILDER” using MEDREPORT data to generate an image file, which then becomes the file to which DOC_SAFE:FILEID points. The image is not formatted, but is simply a listing. The fields of MEDREPORTS are detailed FIG. 2.

MEDREPORTTRACK is a database table containing the status and tracking information of each document. It is related to the data of MEDREPORTS by the common CASEID and REPORTNUMBER fields. Included in MEDREPORTTRACK is the field TEMPLATENAME. If the content of this field is NULL, the standard document format and distribution lists will be used. If a template is named, it will be found in REPORTTEMPLATE. The corresponding (per TEMPLATENAME) entry in TEMPLATESPECS may optionally specify a different distribution list. Whether or not the standard distribution list is used, the template defined by all records with a common REPORTTEMPLATE:TEMPLATENAME will control the content and appearance of a document.

In one embodiment the stage annotated in CURRENTSTAGE is one of:
Wait Document is being reviewed
Proof Back from reviewer, ready for proof reading
Ready Proof read, ready to be sent.
Closed Document and bills have been sent.
Stopped Error indicator.
Error Error indicator.

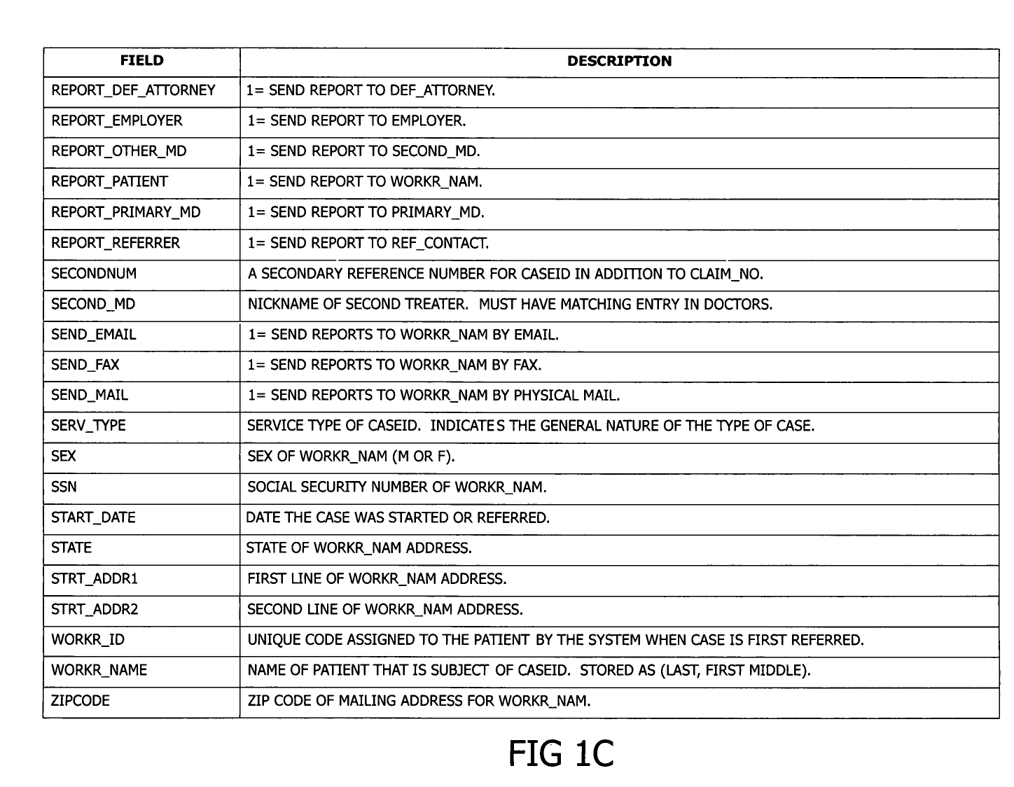

In some embodiments only “Stopped” or “Error” is used. The fields of MEDREPORTTRACK are detailed in FIG. 3.

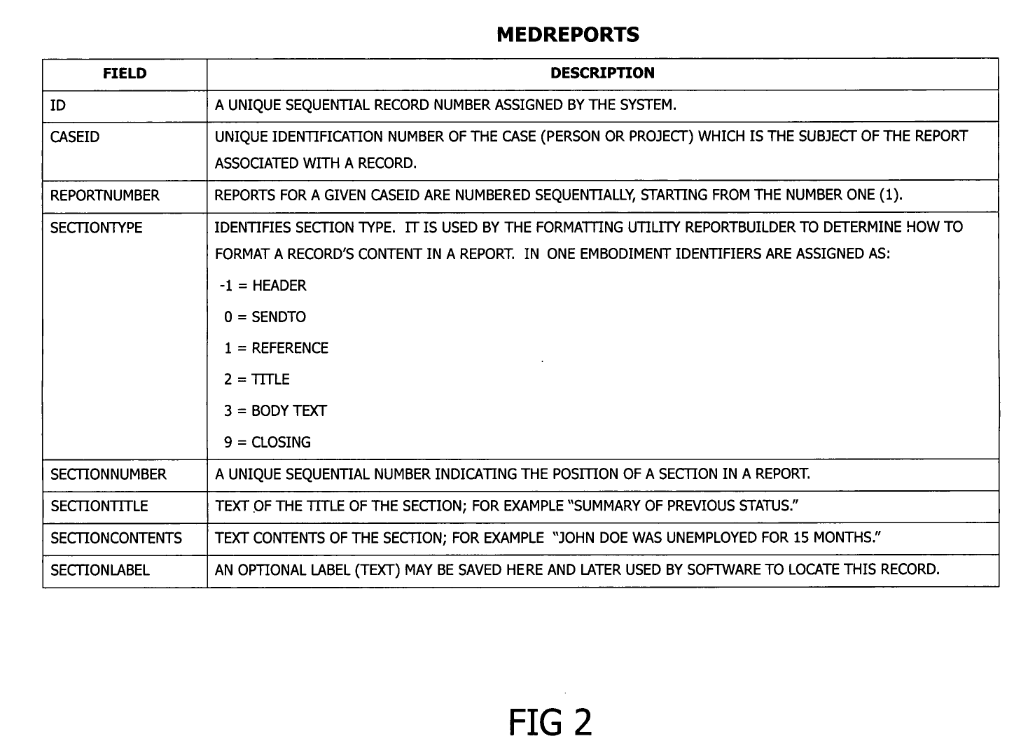

The fields of the database ADJUSTOR, as detailed in FIG. 4, are nearly identical for the databases DOCTORS and ATTORNEY. The fields of ADJUSTOR are detailed here by way of example in FIG. 4.

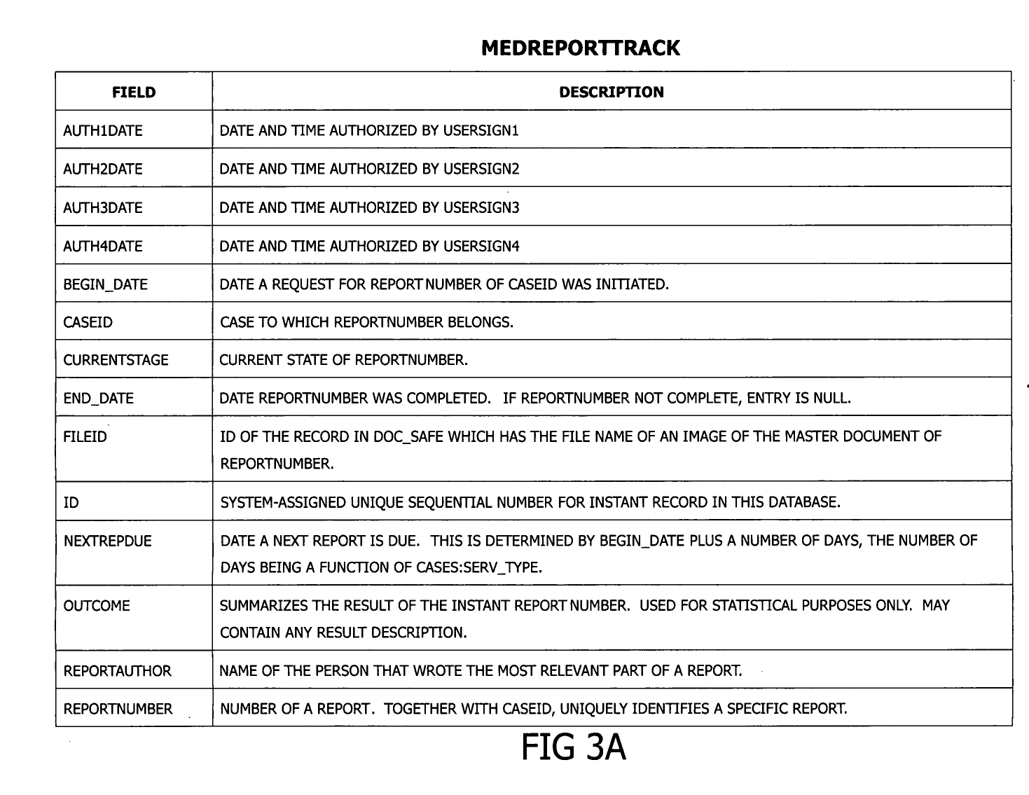

Some of the fields in DOCTORS are in addition to or different than those of ADJUSTOR. These are detailed in FIG. 5. The field COMPANY is not used in DOCTORS.

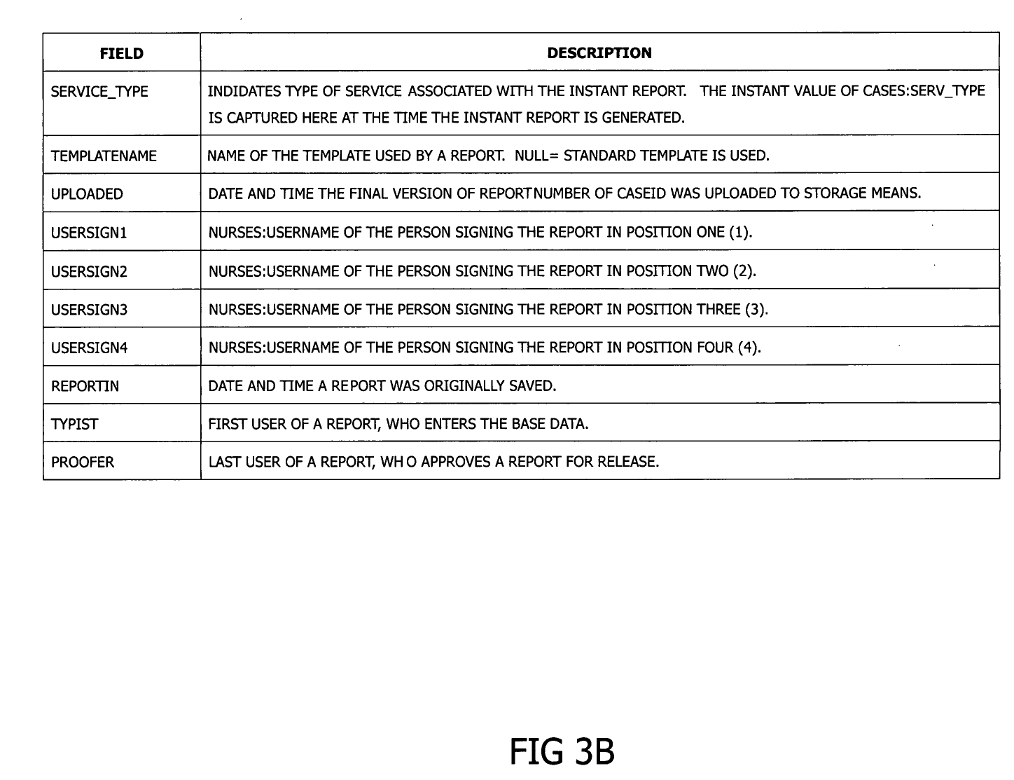

Some of the fields in ATTORNEY are in addition to or different than those of ADJUSTOR. These are detailed in FIG. 6. The field COMPANY is not used in ATTORNEY.

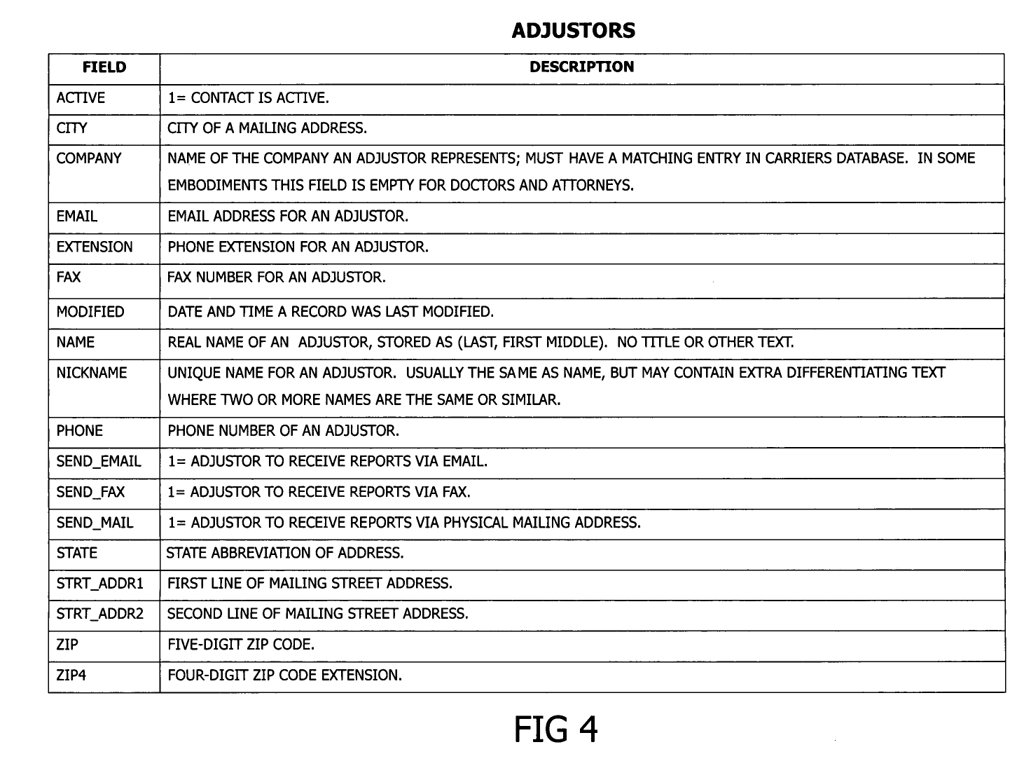

Data for all pertinent individuals employed by the system user company are stored in the NURSES database. This would include physicians, nurses, administrators, and the like. PRIMARY_MD and SECOND_MD are physicians that may treat a patient but are not employees of the system user. Thus PRIMARY_MD and SECOND_MD data is found in the DOCTORS database. The NURSES database fields are detailed in FIG. 7.

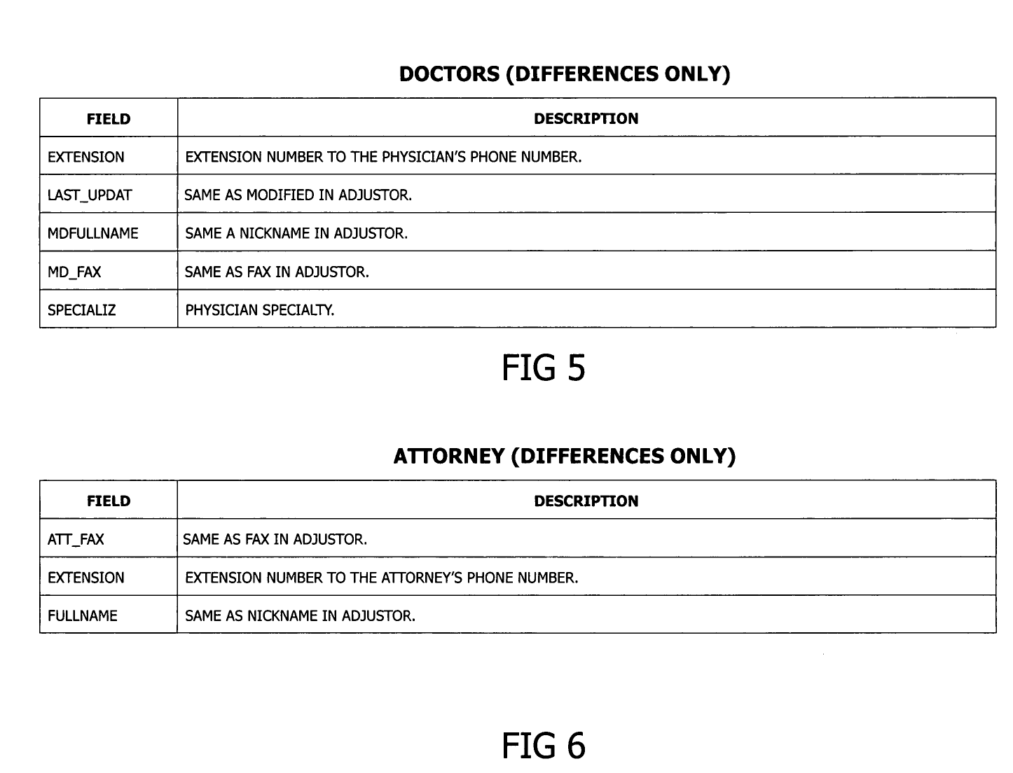

Data pertinent to insurance carriers is stored in the CARRIERS database. Data associated with the main contact at a carrier is kept in the ADJUSTORS database. In the CARRIERS database that person is identified by the ADJUSTOR_NICK field. The other contact information in CARRIERS, such as address, phone number and the like, is associated with the carrier at large, not the main contact. The CARRIERS database fields are detailed in FIG. 8.

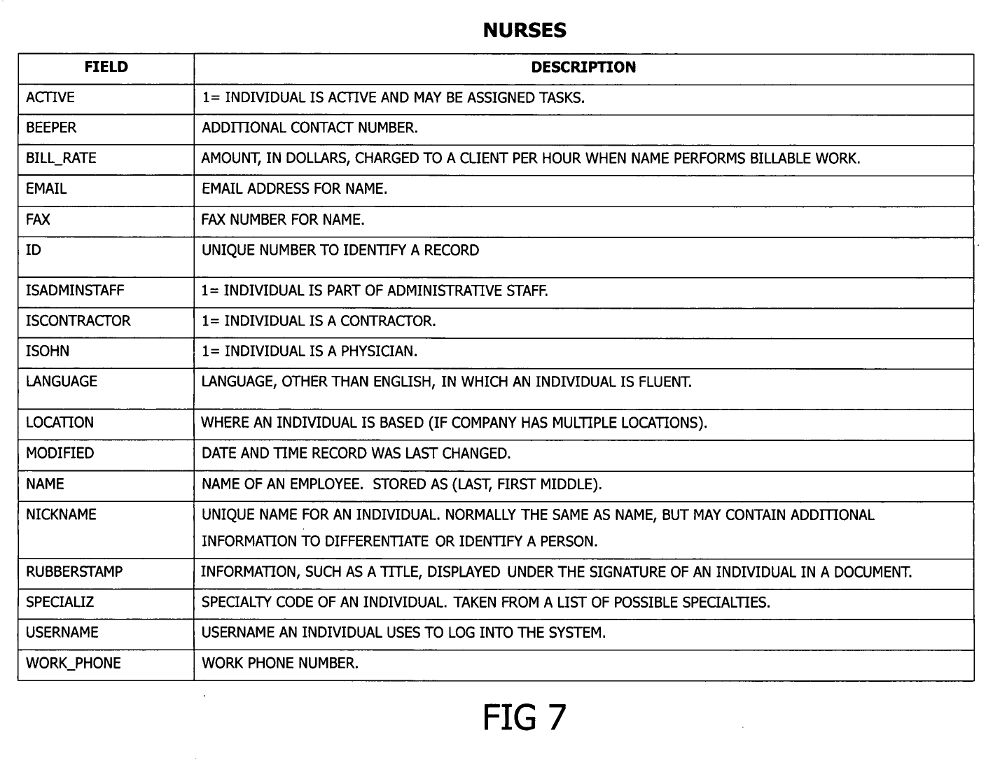

REPORTTEMPLATE is used to control the content and appearance of a document. A given template will contain a record describing each of the sections in the letter/document. The value of the field TEMPLATENAME is the same for all the records comprising a given template. The fields of the database REPORTTEMPLATE are detailed in FIG. 9.

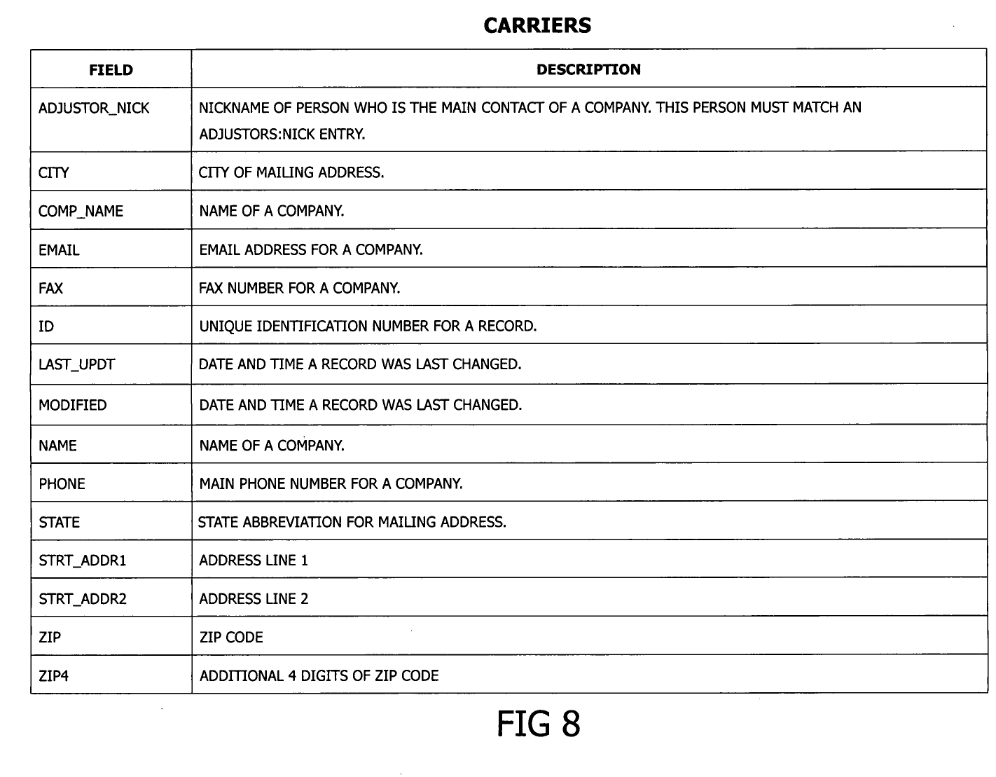

DOC_SAFE is a database table used to track all of the data, images, files and such that are stored by the mass storage means 1706 of the system of the invention. When a user is finished with a file and it is uploaded to DOC_SAFE the user may title the file with an arbitrary name. DOC_SAFE tracks this as ORIGINALFILEID. The system assigns a file name of its own (to avoid duplicates, for example), stored in FILENAME. The fields of the database DOC_SAFE are detailed in FIG. 10.

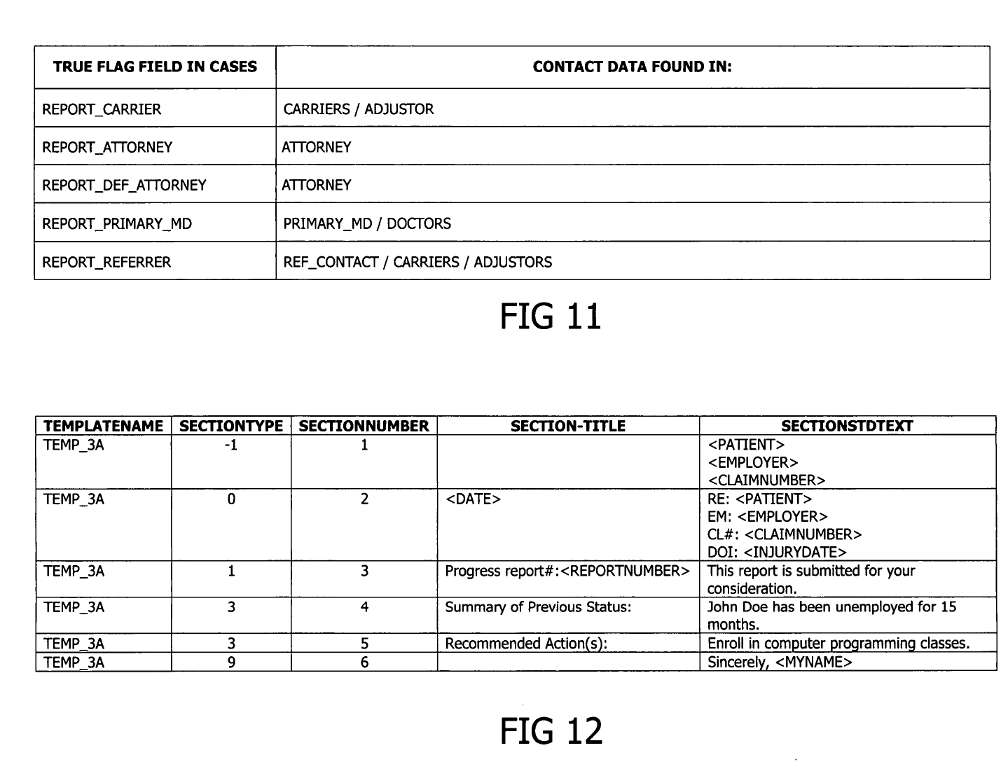

TEMPLATESPECS provides the flexibility of being able to specify any number of recipients for a certain document. The fields are detailed in FIG. 13.

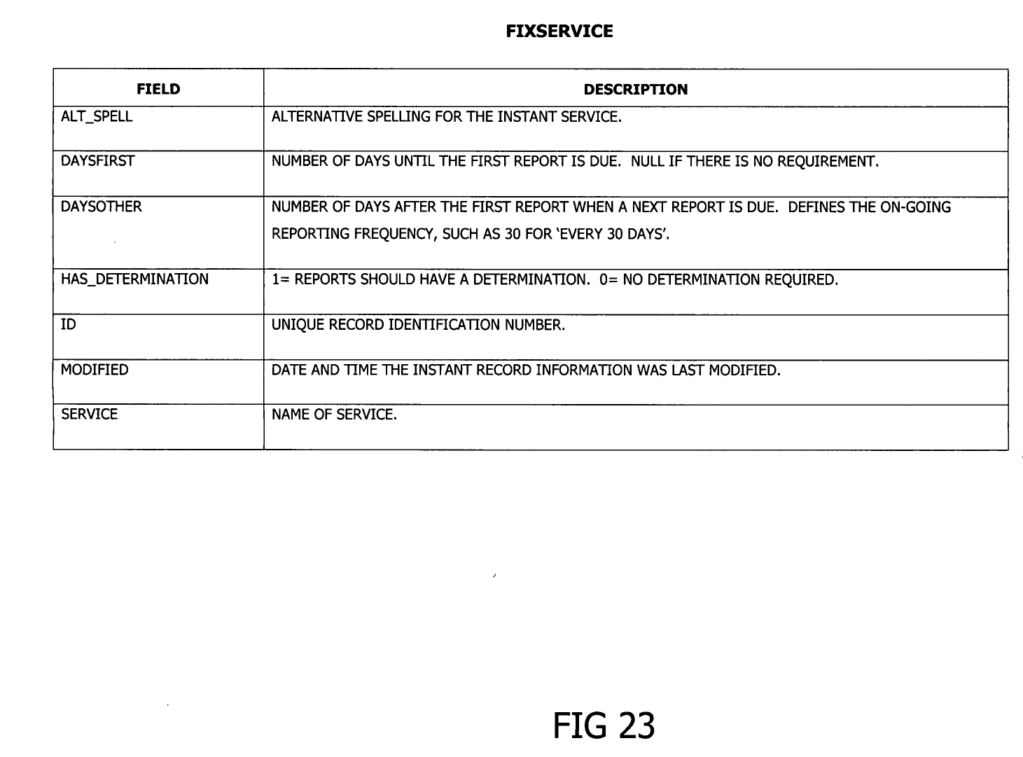

Looking to FIG. 23, TEMPLATECHOICE is used to determine what collection of documents should be generated. There are three cases wherein a non-standard document will be generated: for a certain CARRIER, for a certain OUTCOME, or for a certain SERVICETYPE. REPORTBUILDER queries TEMPLATECHOICE, looking for CARRIERONLYTEMPLATE or OUTCOMEONLYTEMPLATE or SERVICEONLYTEMPLATE bits to be TRUE. If all three are FALSE, REPORTBUILDER will generate the standard (default) set of documents. But if, for example, CARRIERONLYTEMPLATE is TRUE, and CASEID:CARRIER matches TEMPLATECHOICE:CARRIER, the document will be generated using TEMPLATECHOICE:TEMPLATENAME. The same procedure is taken for OUTCOME and SERVICETYPE. Note that any one, two, or three may be selected for a custom document, defined by the TEMPLATENAME of the record. MDREVIEW=TRUE signifies to the document generating program that a physician's document should also be sent.

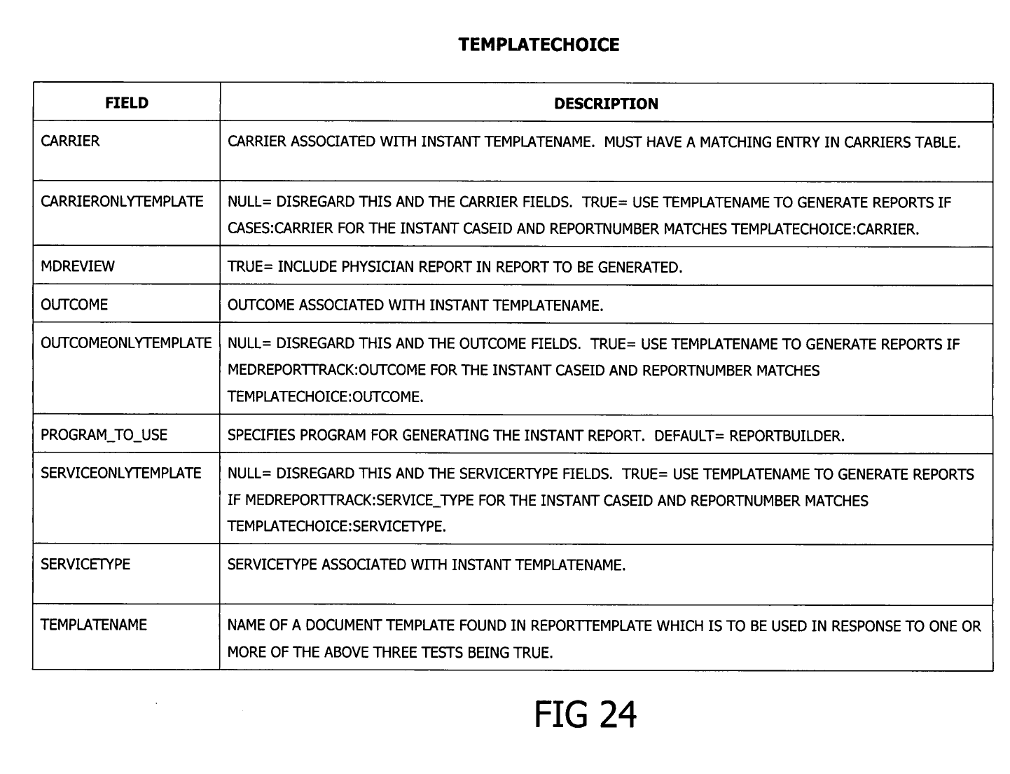

Referring to FIG. 24, FIXSERVICE is used to conform the names and abbreviations which may be used for SERVICETYPE to a standard spelling. Each record has a unique spelling (or possibly misspelling) or abbreviation ALT_SPELL which, when matched, provides the standard spelling in the corresponding SERVICE field. The table is also used to provide timing requirements, wherein DAYSFIRST, if not blank, specifies how many days until the first document is due. DAYSOTHER, if not blank, specifies the frequency (number of days) of follow on documents. Changes are annotated in the MODIFIED field.

### Section 3—Method of the Invention

The present invention comprises a computer-based database system for creating documents, storing documents, and/or sending documents. Documents are created by a system user who reviews, enters, selects and/or modifies data in the various databases. This is accomplished by using a system terminal (1702, 1710), which may be incorporated into a standalone computer, a terminal to a server, an internet connection to a host or server, and the like.

Some data is prepositioned before documents are generated. For example, the NURSES database is populated with the appropriate information associated with those who will use or be managed by the system. The CASES database is added to as cases or projects arise, but is initially empty. Likewise the DOCTORS, ADJUSTORS, ATTORNEY, and CARRIERS databases are initially empty, with additions made as new entries in CASES require. In some embodiments users subscribe to a service which provides or maintains certain of these databases on a more global basis. One example would be a database of all physicians associated with the user's professional association.

MEDREPORTS, MEDREPORTTRACK, and DOC_SAFE are all empty at the time of initial installation, then grow as documents are generated.

In one embodiment a supervisor reviews a document to determine that the text and selected format of the document are correct. A computer monitor based icon labeled “Upload” is clicked with a computer mouse, in response to which MEDREPORTTRACK:CURRENTSTAGE is set to “Ready”.

The automatic distribution process is comprised of three steps:

Step 1: When an authorized user requests a list of documents, query MEDREPORTTRACK for records wherein CURRENTSTAGE=“Ready” and TYPIST=the current user. Make and display a list of matches so that the user can view and review each of the documents on the list. For each one of the documents, as the user indicates that the instant document is approved, select all records from MEDREPORTS that match the CASEID and REPORTNUMBER and add them to a temporary list. Sort these records by increasing SECTIONNUMBER. “Print” an unformatted (not suitable for distribution) listing of all data (MASTERDOCUMENT) into an image file, which is archived by DOC_SAFE. At the end of this step we have the complete text of a document, but the document is not formatted for presentation to a recipient, nor are the recipients yet identified.

Step 2: For a given MASTERDOCUMENT, there may be multiple letters generated and sent to different addressees. For example, a letter may be sent to the patient, a letter containing additional information may be sent to the insurance company, etc. The REPORTBUILDER program will determine a) the correct set of letters to be sent and b) the appropriate addressees and method of delivery for each one of the letters.

To determine the correct set of letters to be sent, REPORTBUILDER queries the TEMPLATECHOICE table for records that match the service type for the instant CASEID and REPORTNUMBER, the insurance carrier for the instant CASEID and REPORTNUMBER, or the outcome of the current work performed for the instant CASEID and REPORTNUMBER, or determines that there are no matches, therefore the default set of documents are to be generated and sent. The list of TEMPLATENAMEs is then the list of all documents (since each document is generated from MASTERDOCUMENT according to a template).

To determine the correct addressees and delivery method for each letter, REPORTBUILDER queries the TEMPLATESPECS table for each of the templates in the above list and checks the content of the field “OVERRIDE_CASE_RECIPIENTS”. If the result is absent or NULL, then the list of recipients is taken from the CASES table as described below. Otherwise, the program examines the contents of the fields SEND_ATTORNEY, SEND_ADJUSTOR, etc. Each time this Boolean field is TRUE, the corresponding contact (attorney, adjustor, etc.) will become a recipient of a document. The delivery method and address will then be obtained by consulting the records of the instant contact.

If OVERRIDE_CASE_RECIPIENTS is FALSE (or NULL) we build a list comprising all recipients of the instant document per CASES:REPORTNUMBER for CASES:CASEID. This is done by testing the CASES “Send document to . . . ” fields, previously described (FIG. 1). Each TRUE flag field has a corresponding nickname in CASES which corresponds to a record in ATTORNEY, CARRIERS, DOCTORS, or ADJUSTORS, where all potentially needed contact information (email address, fax number, physical mailing address) is found. For REPORT_EMPLOYER=1 or REPORT_PATIENT=1, the contact information as well as delivery method(s) is found in CASES itself. The database CARRIERS points to the nickname in ADJUSTORS to be used for insurance CARRIER contact.

Any given recipient will have as many list entries as there are flags for delivery method. For example, a recipient may have requested an email and physical mail delivery, in which case there are two LIST entries, one for each method, as shown in Table 1.

TABLE 1

| NAME | ADDRESS | METHOD |
|---|---|---|
| Potter, Harry | hpotter@witch.com | email |
| Potter, Harry | 408-555-1212 | fax |
| Mouse, Mickey | 99 Disney Ln., Cupertino, CA | mail |

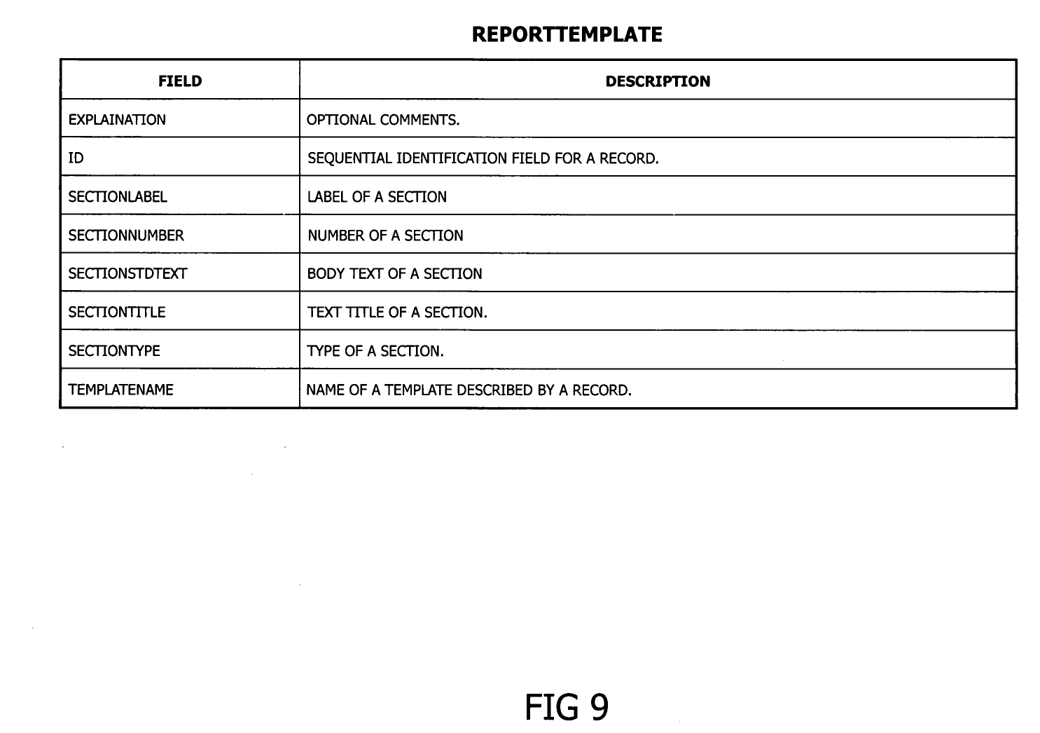

Referring to FIG. 11, contact information for sending documents may be formed in response to the various flag bits and data in CASES. For example, if CASES:REPORT_CARRIER is TRUE, look for a match of CASES:CARRIER in CARRIERS:NAME. Once that record is found, find a match between CARRIERS:ADJUSTOR and ADJUSTORS:NICKNAME. The distribution methods and contact information is in the same record of ADJUSTORS as that of the match. For another example, if CASES:REPORT_ATTORNEY is TRUE, find a match for ATTORNEY:FULLNAME and CASES:ATTORNEY. The matching record in ATTORNEY will then provide the delivery method preferences and contact information as needed.

The software utility REPORTBUILDER generates fully formatted images of each document, one per recipient on the list. Each image file is sent by the server to the mass storage means for safe keeping, the location of which is tracked by DOC_SAFE At the end of this step each document has been completely formatted, generated, and saved into an image file.

Step 3: The distribution of documents is automated. Thus the person generating a document associated with a certain CASEID does not need to look for or even know any of this information. When a document is formalized (i.e., completed, proofread, and released) no further human action is needed; the document is automatically sent to the appropriate parties via the requested means. TEMPLATESPECS (FIG. 13) controls to whom a document is sent. If MEDREPORTTRACK:TEMPLATE is NULL, a default template is used and the distribution of documents is per the CASES “Sent to . . . ” list. If MEDREPORTTRACK:TEMPLATE contains a template name, the field OVERIDE_RECIPIENTS_LIST is tested and if TRUE the distribution of TEMPLATESPECS:TEMPLATENAME is used, otherwise that of CASES is used.

Delivery by email and fax are immediately handled by the computer. For email delivery, a file that contains a formatted image file of the document is sent as an email attachment via the ISP 1714. The email is sent with no further human intervention.

For fax transmission, a cover page is automatically generated with the name and fax number of the recipient and may include a short message. A document is sent as additional pages in the fax, “printed” from the image. The fax is sent from the computer with no human intervention. It is well known to those skilled in the art how to generate an email with an attachment, as well as to send a fax from a computer. In one embodiment the fax is sent via email to a fax sending service. In another embodiment the fax is sent by the computer (server) to the recipient's fax machine using a fax modem, and may optionally be printed in hard copy for subsequent sending by an outgoing fax machine. All such methods are referred to by FIG. 17 item 1712.

For physical mailing, a document is placed into a queue. The queue is maintained on the computer. The queue is a list of image files to be printed and put in envelopes to be sent via the postal service or via a courier service. After printing and enveloping a document, the person responsible for mailing clears its entry from the list. The computer then removes the sent letters from the queue list and may record by whom and when the document was mailed.

At the end of this step, each formatted document has been permanently stored and indexed in the database by DOC_SAFE.

### Templates

In one embodiment the generation of documents is done using templates. A template specifies default text for a document. In some embodiments the text is fixed, in others the text is merged with information from the database. Templates may contain variables that represent data found in the various databases, such as the subject's name, or values that are automatically generated, such as the creation date of the document. After a template is processed (that is, its variables, if any, evaluated, then an initial document loaded to the user's terminal), the user can modify the text as appropriate.

Templates are held in “REPORTTEMPLATE”, a database table very similar, including structure, to MEDREPORTS, previously described. REPORTTEMPLATE contains the initial text for a document which uses a certain template rather than the default template. When the generation of a document is initiated, the user's computer terminal will present an initial document filled in with the information per the document template, including data obtained from the database. The user will then be able to add or modify the document as needed. When the document is completed and ready for the next stage of processing, it is first saved into MEDREPORTS, which is the sole repository of all documents.

Since a template is not associated with any particular case or project, the REPORTTEMPLATE database does not have the fields “CASEID” or “REPORTNUMBER.” A common value in the field “TEMPLATENAME” identifies all the records comprising a given template. A given template may use the variables ‘CASEID’ and ‘REPORTNUMBER’ by calling for them in one of the records, but they are not part of the REPORTTEMPLATE structure per se.

The database table REPORTTEMPLATE is detailed in FIG. 9. A template-based document has the same types for SECTIONTYPE as documented in MEDREPORTS, FIG. 2. Each of the sections has a title (SECTIONTITLE) and contents (SECTIONSTDTEXT). Whenever a new document is generated based on a template, all the titles, contents, and labels are copied from the template to the corresponding section of the document. To more conveniently generate documents, the method of the present invention uses text that changes depending upon the situation. For example, a template could indicate where the instant date should go, where the name of the subject goes, etc. The present invention provides this by using variables. There is a specific set of variables in a template (this is a fixed set and cannot be modified by the user). Variables are signified by angle brackets “< >.”

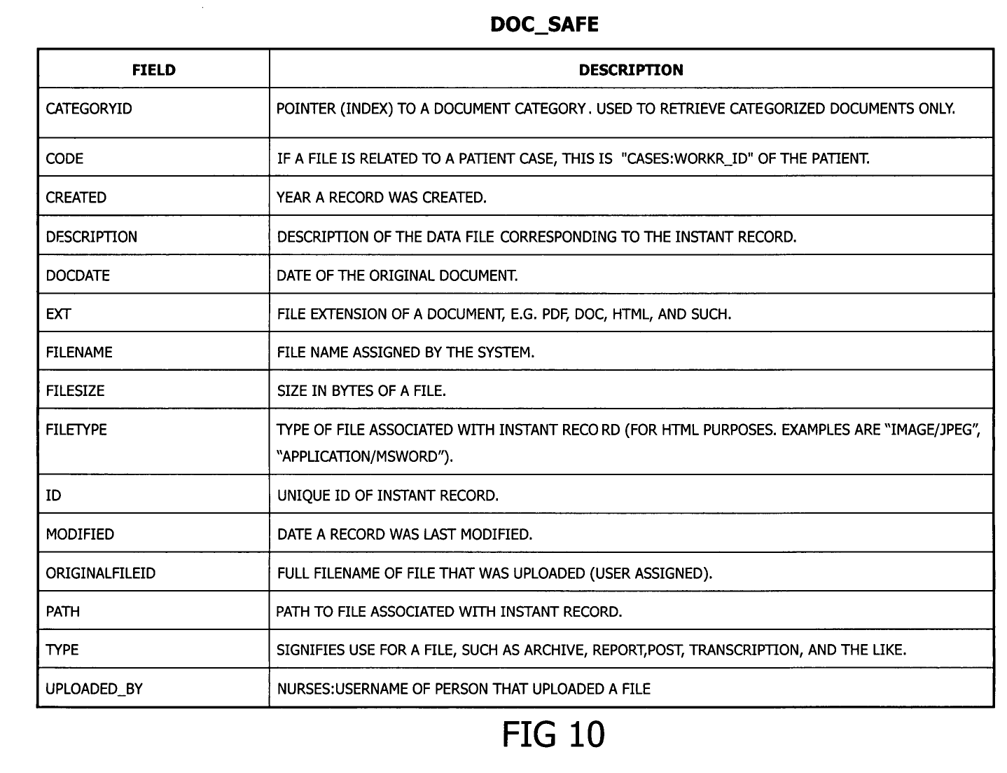

Variables are evalated when a document is generated based on a template. FIG. 12 illustrates an example template. A variable indicates that a specific place in a document built using such a template should contain a value which is obtained from the database.

### Section 4—Generating Reports From Templates

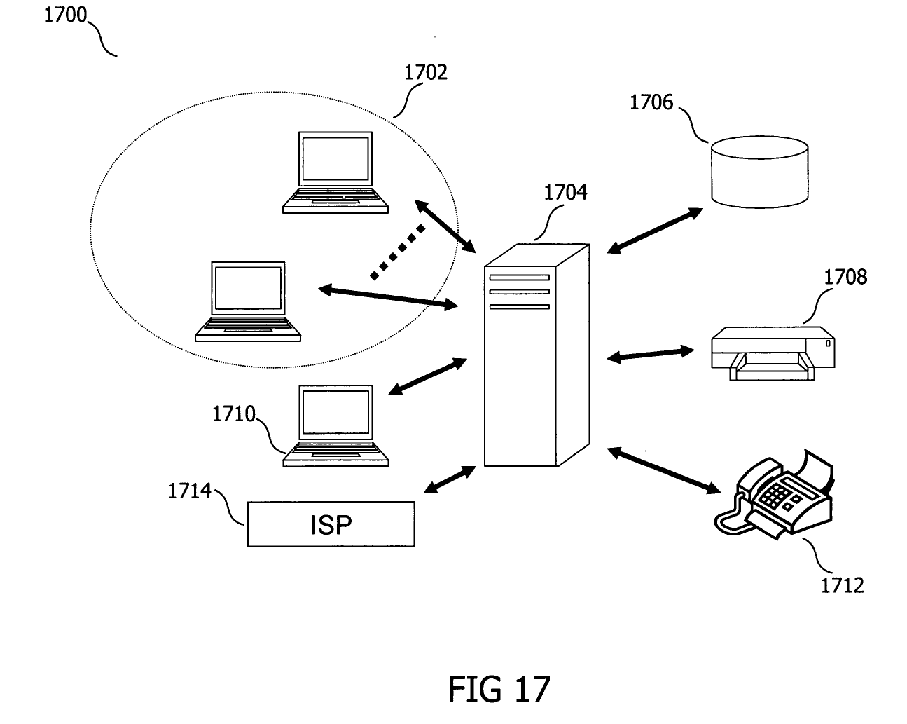

As illustrated by FIG. 18, for a document for CASEID, REPORTNUMBER, and TEMPLATENAME from MEDREPORTTRACK, wherein TEMPLATENAME may be a named template or NULL (signifying the default template), a document is generated per the following steps:
Determine if a custom template or the default template is to be used.
Generate a temporary list of variables from TEMPLATENAME, including the name of each variable and its instant value.
Evaluate the variables.
Provide the document to the user's terminal, using the filled-in data per TEMPLATENAME.
Save the document to MEDREPORTS after any editing required.
If the default template was not used, determine if a custom (TEMPLATESPECS) or standard (CASES) distribution list is to be used, then distribute accordingly.

Most variable values will be determined by first fetching the record for the given case. This is easily found since CASEID is known. For example, consider a document wherein the patient's name is needed. The template uses the variable <patient>. This is found in CASES:WORKR_NAME for the instant CASEID.

As another example, to determine the adjustor information, first get CASES:ADJUSTOR for CASES:CASEID. Next, retrieve the record for this contact by the steps of:

Select the ADJUSTOR record for ADJUSTOR:NICKNAME which matches CASES:ADJUSTOR.

Set <adjustor>=NAME.

Set <adjustoraddress>=STRT_ADDR1, STRT_ADDR2, CITY, ZIP.

Set <adjustoremail>=EMAIL.

Operating upon a temporary version of a document in memory, wherever a variable is found, its value is substituted. The filled in initial document is then loaded to the user's terminal for review and editing as needed. When complete, the updated document is saved to the MEDREPORTS database and the automated delivery proceeds as previously described.

Variables are included in the operating software. They are not able to be modified by system users. Table 2 lists the variables used in some embodiments of the invention. One skilled in the art would be able to add other variable for various end purposes.

TABLE 2

| VARIABLE NAME | VARIABLE USE |
|---|---|
| <header> | Header for each page containing patient name, date |
| | of document and page number. |
| <pagenumber> | Number of the current document page. |
| <sendto> | Name of carrier contact and address to receive a |
| | document. |
| <reference> | Reference to patient, employer, claim number. |
| <claimnumber> | Contents of CASES: CLAIM_NO for CASEID. |
| <reportnumber> | Number of current document or visit. |
| <diagnostics> | Contents of CASES: DIAGNOSTIC for CASEID. |
| <datestart> | Starting date for a document. |
| <datereceived> | Contents of CASES: START_DATE for CASEID. |
| <dateend> | Ending date for a document. |
| <decisiondate> | |
| <birthdate> | Contents of CASES: BIRTHDATE for CASEID. |
| <injurydate> | Contents of CASES: INJURYDATE for CASEID. |
| <referraldate> | Contents of CASES: START_DATE for CASEID. |
| <patient> | Contents of CASES: WORK_NAME for CASEID. |
| <patientaddress> | Address of patient or worker. |
| <ssn> | SSN of patient. |
| <adjuster> | Name of carrier contact person (first and last name) |
| <adjlastname> | Last name of carrier contact person |
| <address> | Address of carrier contact person |
| <attorney> | First and last name of Applicant Attorney |
| <carrier> | Name of insurance carrier |
| <employer> | Employer |
| <managername> | Name of person in charge of this patient |
| <manageremail> | Email of manager |
| <managerphone> | Phone of manager |
| <myname> | Name of person writing the document (first and last |
| | name) |
| <myemail> | Email of person writing the document |
| <myphone> | Phone of person writing the document |
| <attorney> | Name of applicant's attorney |
| <providers> | Name and specializations of service providers for |
| | this case |
| <providerl> | Name of first treater or provider |
| <providerladdress> | Address of first provider |
| <MDSSN> | ID of first provider |
| <provider2> | Name of second treater or provider |
| <provider2address> | Address of second provider |
| <casecode> | Patient code in the system |
| <diagnostics> | Contents of the diagnostics field in case roster |
| <serv_type> | Service type |
| <condition> | special instructions or condition |

### Section 5—Multiple Recipients of a Common Document

A template may further specify a plurality of recipients for a given document. Some correspondence, letters, or documents for a given case may need to be sent to a different contact than the contact list specified by CASES for CASEID. For example, a standard letter might be sent to a physician requesting certain information. Perhaps the letter should also be sent to the physician PRIMARY_MD, but not to the referring contact or attorney as stated in the list for document recipients by CASES.

Refer to the field details of TEMPLATESPECS in FIG. 13. Note the field OVERIDE_RECIPIENTS_LIST controls whether the recipient list from CASES is used (FALSE) or instead the list from the record in TEMPLATESPECS (TRUE). Use of the TEMPLATESPECS database allows specifying that letters generated with a given template should be sent to specific contacts. The program utility for finding recipients queries the database to determine if there is an entry for the template used for the document of interest. If an entry is found, the above procedure is followed to determine the recipients.

### Generating Multiple Reports from a Single MASTERDOCUMENT

In one embodiment of the present invention different looking documents are sent to different recipients. Each of the alternative documents may include specific items extracted from the MASTERDOCUMENT. Once the MASTERDOCUMENT and one or more templates are available for each of the alternative documents, all of the alternative documents are generated and sent automatically to the appropriate recipients. Consider the following example:

At the completion of a given study, it is required to send a variety of documents:

A document to the insurance claims examiner containing:
What was requested in the claim
What is being approved or denied
Manuscript of medical recommendation
Medical comments

A letter to the patient containing:
What was requested
What is being approved or denied

A letter to the treating physician (physician who entered the claim on behalf of patient) containing:
What was requested
Transcript of medical recommendations
What is being approved or denied

All the documents and documents are built using a template. This is also true for a MASTERDOCUMENT. Each section of a MASTERDOCUMENT is generated in accordance with one record in the REPORTTEMPLATE database wherein TEMPLATENAME=“master”. The template for the MASTERDOCUMENT is determined when a system is installed for use by a user. The needs of one user may be much different than another, therefore one user may define the master document template uniquely compared to another. But within any one installation there is only one template for generating a MASTERDOCUMENT, hence all MASTERDOCUMENTs are initially the same in terms of number of records, data types, and such. In one embodiment the user's terminal display offers the ability to add at least one extra field name and field content. The user may enter whatever is desired; all entries will be text data type. The extra field(s) becomes an additional record in MEDREPORTS, is given a sequential SECTIONNUMBER, and prints on the formatted document under the preceding sections.

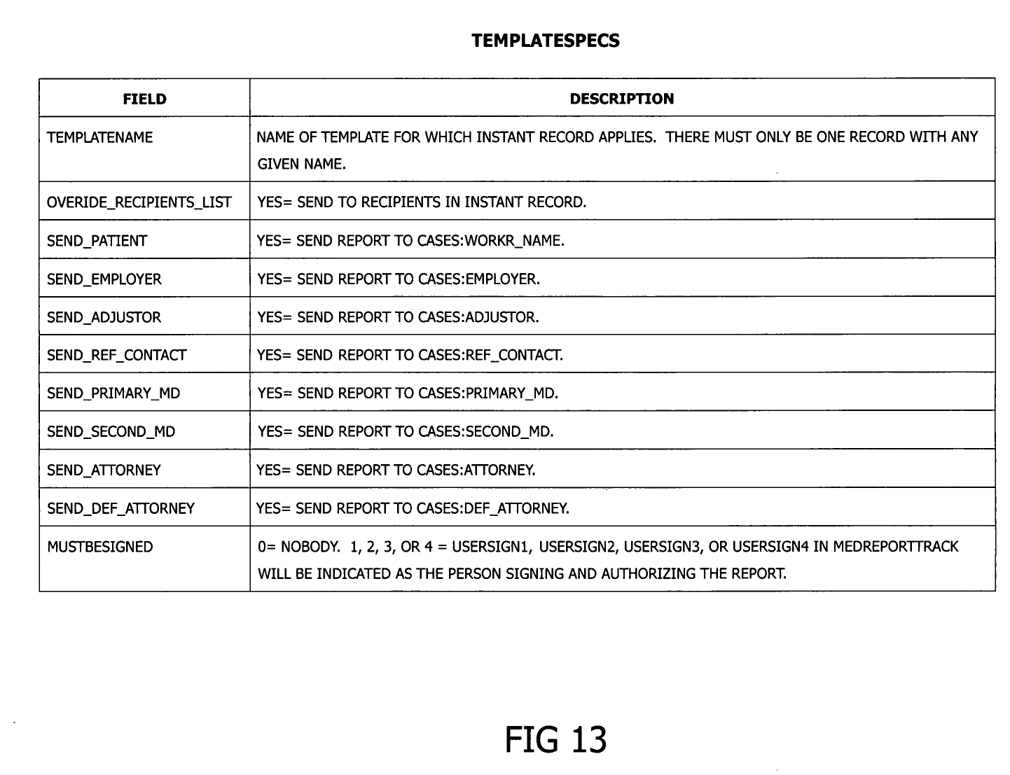

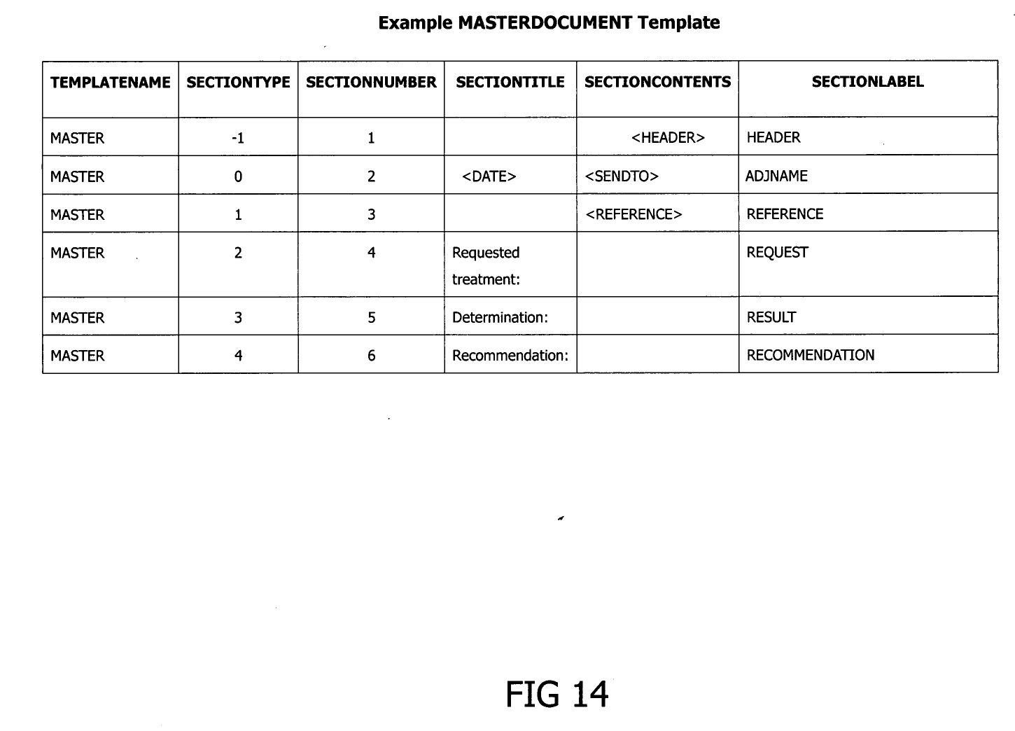

An example is provided. Assume FIG. 14 is the master template in REPORTTEMPLATES for a system installation. The contents of SECTIONLABEL for each record will be copied to MEDREPORTS:SECTIONLABEL for a given CASEID and REPORTNUMBER. This provides for another document template to be able to find that record and its SECTIONCONTENTS by using the SECTIONLABEL as a variable. Taking the example further, look to FIG. 15, created per the template of FIG. 14. That is, FIG. 15 represents MASTERDOCUMENT for CASEID=7575 and REPORTNUJMBER=1. <HEADER> is replaced with the header information specified by the variable “<HEADER>”, described elsewhere as one of the variable functions. Likewise “<REFERENCE>” is replaced per that variable's specification. When the document is presented to the user's terminal, the user entered “Hand surgery”, “Surgery approved”, and “Schedule immediately”, are then captured into the MASTERDOCUMENT. Note that in this example there is no data for “<SENDTO>”, thus the SECTIONCONTENTS is empty. Note that SECTIONTITLEs are not labels, but simply the text which will be printed on the formatted document above the SECTIONCONTENTS information.

The present invention uses SECTIONLABEL as a variable in other templates. In other words, again referring to the example shown in FIG. 14, if any other template refers to “<RESULT>”, the variable <RESULT> will be substituted with the actual contents of the field SECTIONCONTENTS in the MEDREPORTS database, where the value of MEDREPORTS:SECTIONLABEL is “RESULT” and the CASEID is 7575 and document number is 1 (for example). Alternative documents are produced and distributed per the particular template used and the TEMPLATESPEC associated with it (which may or may not direct a different recipient list), and an image of the formatted document sent to mass storage and logged by DOC_SAFE, but they are all still the same document number. That is, the MASTERDOCUMENT data may be reused for alternative documents, which may only use a subset of the data available, and the alternatives are not saved back into MEDREPORTS, only the MASTERDOCUMENT.

The process is very similar to that previously described, wherein variables such as <PATIENT>, <ADJUSTORADDRESS>, and such are substituted with information extracted from the database. When a document is being generated, the MASTERDOCUMENT is found for the given case and document. That is, all fields are selected from MEDREPORTS wherein CASEID=desired case and REPORTNUMBER=desired document.

Next, a translation table is created containing the section label (which will be the name of the variable) and the section contents (which will be the value), as shown in Table 3.

TABLE 3

| SECTIONLABEL | SECTIONCONTENTS |
|---|---|
| <HEADER> | John Doe |
| | May 27, 2005 |
| | Claim #1234 |
| <SENDTO> | |
| <REFERENCE> | John Doe |
| | Company, Inc. |
| | Claim #1234 |
| <REQUEST> | Hand surgery. |
| <RESULT> | Surgery approved. |
| <RECOMMENDATIKON> | Schedule immediately. |

Once the list exists and is complete, the document is created by locating all incidences of each variable and substituting them with the value from the table.

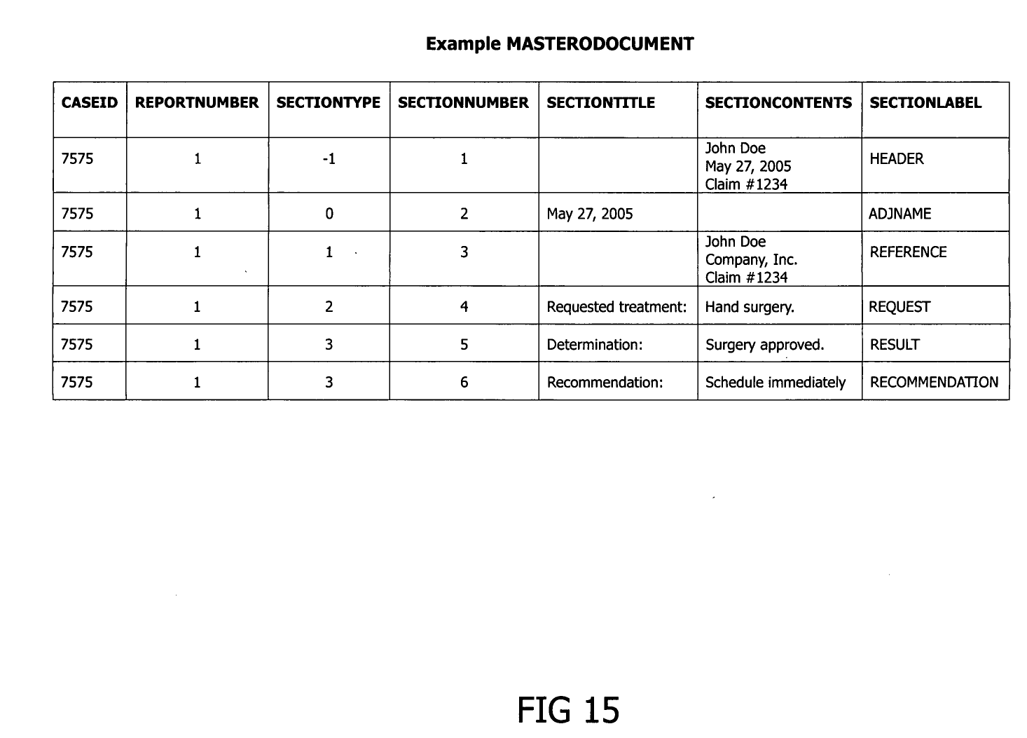

FIG. 16 is an example of a template for a letter to a client. Note that “SECTIONLABEL” is not relevant in any template except the MASTER template in REPORTTEMPLATES. It is important that labels are defined in the MASTER template because values are taken from it by other templates, using the SECTIONLABEL values.

A template can mix variables taken from the database (PATIENT, PATIENT ADDRESS, etc.) and/or variables defined in the master document (REQUEST, RESULT). REPORTBUILDER processes both types of variables.

Once the alternative documents are generated, they are forwarded to the appropriate recipient(s) using information in the TEMPLATESPECS database, just like any other document.

### Controlled Sequential Cooperation for Document Preparation

It may be useful for multiple parties to cooperate in creating a document. The cooperative mode of the present invention provides for one or more of the following functions:
Each person to write a different section of the document.
Some persons to see but not change sections written by another person.
Each person to notify another person that a document needs attention.
Persons to add/see administrative notes to be shared by all persons involved.
Persons at a supervisory level to modify contents and flow of a document.
Supervisory level persons to see the current stage, history and notes for all documents.

Each document has a unique manager that is ultimately responsible for the quality and content of the document. Documents are tracked. Each document has a due date and each time a document needs attention by a different person, a log entry is made in MEDREPORTTRACK:NEXTREPDUE and notification emails sent. Among others, an application wherein this process is useful is the control of Workers' Compensation Utilization Review. Typical steps are shown in Table 4.

TABLE 4

| STEP | WHO | ACTION OR RESPONSIBILITY | STAGE |
|---|---|---|---|
| 1 | Office Staff | Enter a new referral's information. | WAIT |
| | | Assign a nurse to manage* | |
| 2 | Nurse | Enter clinical information. | WAIT |
| | | Review applicable guidelines. | |
| | | Enter guidelines summary. | |
| | | Enter recommendation. | |
| 3 | Nurse | Is a physician review needed? | |
| | | No, so exit, else next step | |
| 4 | Nurse | Assign physician for review* | WAIT |
| 5 | Physician | Reviews info provided by nurse | REVIEW |
| | | Reviews patient records | |
| | | Writes recommendation | |
| | | Notifies nurse* | |
| 6 | Nurse | Reviews physician recommendations | PROOF |
| | | Proofs documents generated | — |
| | | Verify if recipients are correct | — |
| | | Sends letters | — |
| | | Closes requests | CLOSED |

“*” Indicates that an email notification is sent to the next person assigned to the case.

An email notiifies someone that they should log on to the secure sever because there is somthing awaiting their attention.

Referring to the steps illustrated by Table 4, consider the following example:

STEP 1. When a new request comes in, an office staff person locates the record or creates the record if the patient is new. By clicking a terminal icon “New request,” a new entry in MEDREPORTTRACK is created with the CASEID and the next available REPORTNUMBER for the instant patient. BEGIN_DATE is set to the current date, and CURRENTSTAGE is set to “WAIT”. The same office staff person may assign a manager to the case, or this can be done later by a supervisor. Whenever this is done, the field MEDREPORTTRACK:TYPIST will be filled in with the name of this manager and an email notification sent.

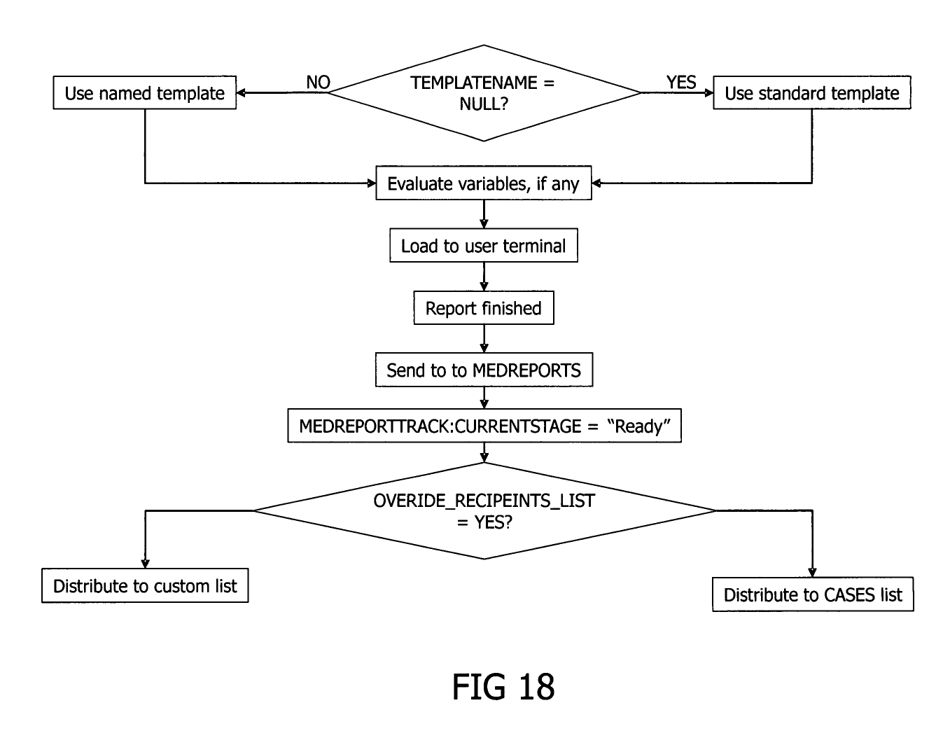

STEP 2. Any nurse that logs in (an example of a terminal screen for one embodiment at this step is shown in FIG. 19) will see a list of documents that need his/her attention. The program utility NURSECASES provides the list by selecting from MEDRETPORTTRACK all records wherein CURRENTSAGE=WAIT and TYPIST=name of this nurse. Physicians will not see any documents wherein CURRENTSTAGE=WAIT. Physicians are identified by the NURSES:ISOHN field flag.

Each name in the list is a hyperlink. If the nurse clicks on the name, a new screen opens with boxes where the nurse can enter the appropriate information (whatever is entered in these boxes will be saved in the corresponding section in the MEDREPORTS database).

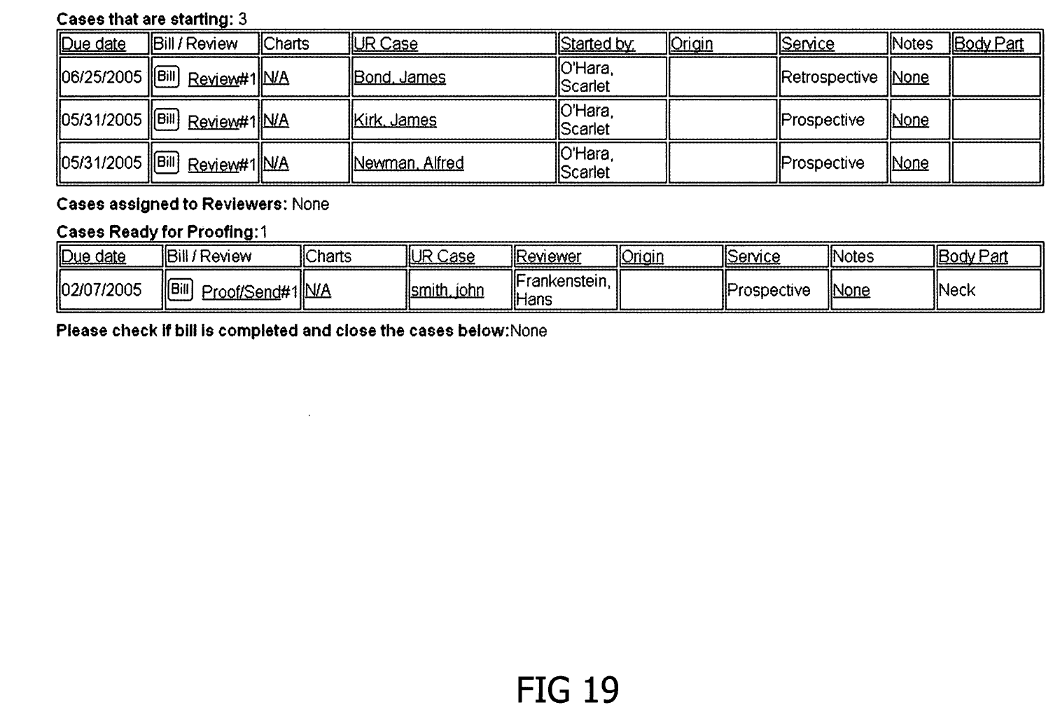

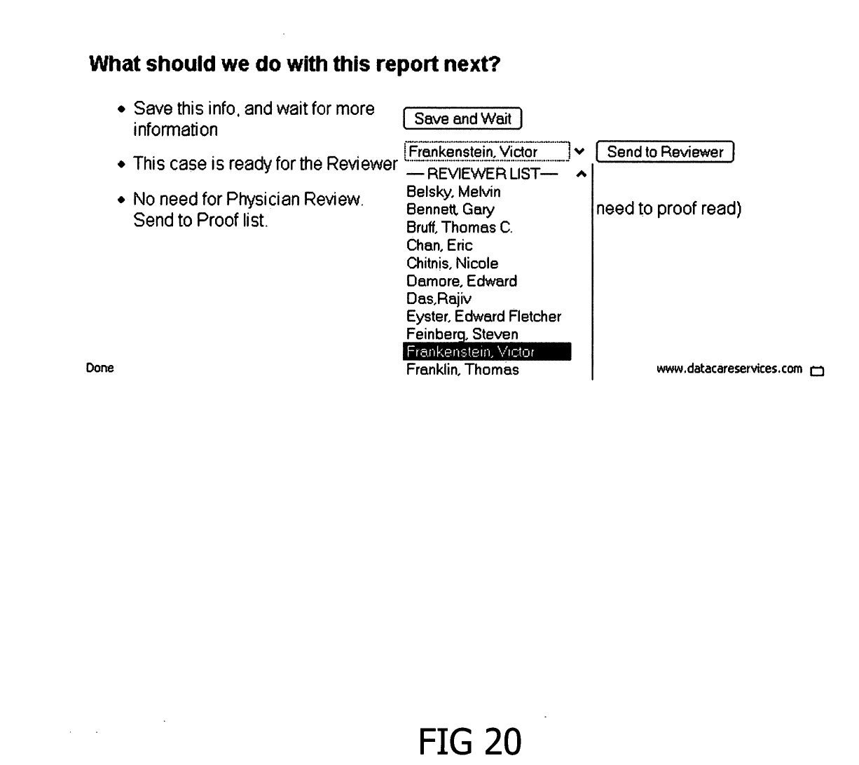

STEPS 3 & 4. A drop down menu (see FIG. 20) with a selectable (by mouse) button at the bottom of the page allows the nurse to choose a name from the list, which has the names of all staff members that have NURSES:PHYSICIAN=YES. If the nurse makes a selection and SELECTS “Send to Reviewer,” a utility “SENDREVIEW” is called along with the information and CURRENTSTAGE is set to “REVIEW”. If a physician review is not needed the nurse hits the other button “No physician review needed.” This will set CURRENTSTAGE=PROOF and regenerate the list. An example of the monitor presentation at this stage is shown in FIG. 21. In the example shown, the case was assigned for review to Dr. Victor Frankenstein.

Upon exiting WAIT, MEDREPORTTRACK:USERSIGN1 is set equal to the USERNAME of the nurse who accomplished this step and the instant date and time written into AUTH1DATE.

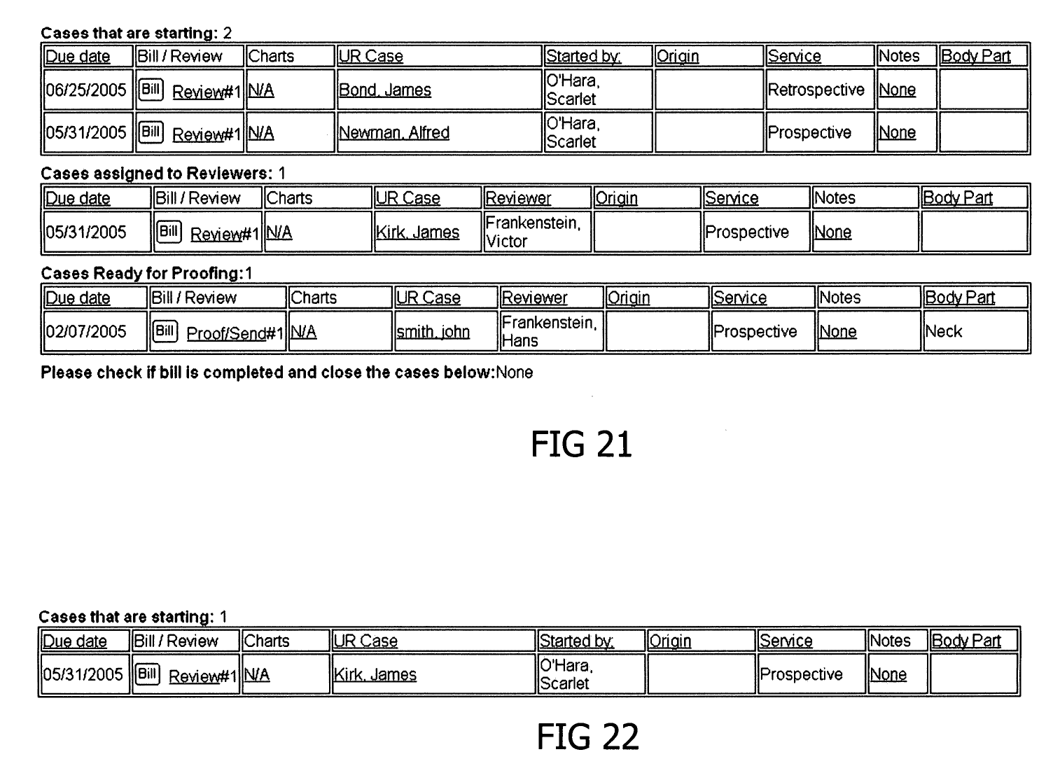

STEP 5. When a physician logs into the system, the physician is presented with a list (by NURSECASES) of all cases requiring his attention. This is accomplished by searching MEDREPORTTRACK for all instances of CURRENTSTAGE=REVIEW wherein NURSE:ISOHN=1 and MEDREPORTTRACK:REPORTAUTHOR selected in STEP 4 is the same as the login ID of the current user. At this time MEDREPORTTRACK:REPORTIN is set to the current date and time. When Dr. Victor Frankenstein logs into the system, the monitor will present him with a view as shown in the example of FIG. 22.

When a physician clicks on the patient's name, a new screen pops up with case information, the information entered by the nurse, and empty text boxes where physicians enter any recommendations. The physician cannot change any information already provided by the nurse.

Upon completion, the physician clicks on a button which updates MEDREPORTTRACK fields as:
CURRENTSTAGE=PROOF
REPORTIN=current date and time stamp.

An email is sent to the nurse, and the screen regenerated with the patient whose review was completed now missing from the list.

Upon exiting this step, USERSIGN2 is updated with the USERNAME of the physician if a physician did in fact review the case or with that of the nurse if “No physician review needed” had been selected. AUTH2DATE is written to with the date and time of exiting this step.

STEP 6. The nurse (TYPIST) reviews all information and approves for distribution. The nurse's USERID is written to USERSIGN3 and the instant date and time written to AUTH3DATE. If TEMPLATESPECS:MUSTBESIGNED=0, no authorizing name is provided. If this field is non-zero, the appropriate NURSES:RUBBERSTAMP is appended to the document.

### Section 6—An Example Document

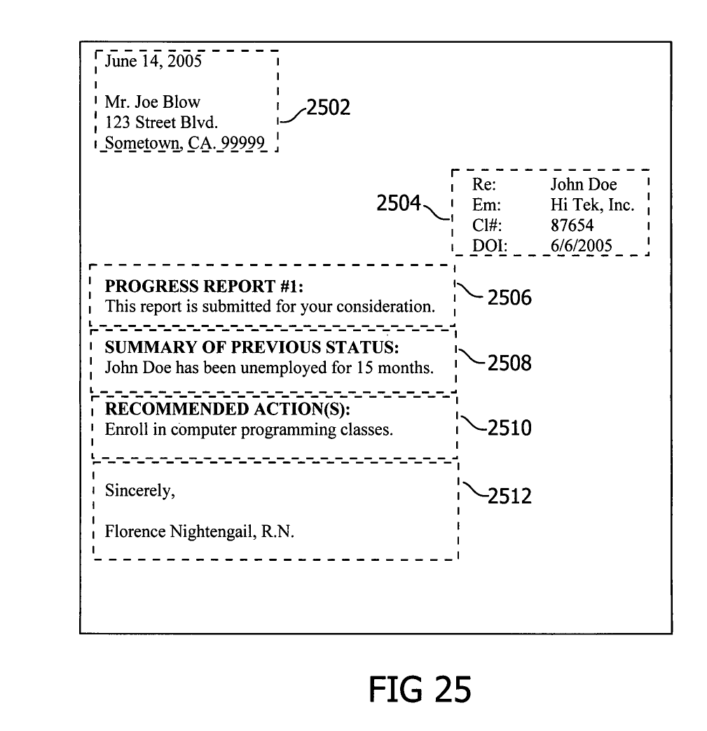

An example document is illustrated by FIG. 25. The actual document may span several pages, but this example illustrates a one-page document. This example is based upon the template TEMP_3A per FIG. 12. The document is constructed in sections. SECTIONNUMBER=1 (FIG. 12) captures the pertinent data. Text blocks 2502 and 2504 (FIG. 25) are formatted and printed using the data from SECTIONNUMBER=2. Text block 2506 is printed using the SECTION-TITLE and SECTIONSTDTEXT of SECTIONNUMBER=3. The remaining text blockx 2508, 2510, and 2512 similarly correspond to SECTIONNUMBERs 4,5 and 6 respectively.

In some embodiments, the following notes are appropriate:
Section titles may be empty or contain one line of text.
Section contents may be empty or may have a virtually unlimited in length.
There is no practical limit on the number of common text sections used in a document. Each section may contain a title (bolded) and contents.
There is only one closing section and it is displayed after all common text sections.

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, and/or use of equivalent functional steps for steps described herein. Such insubstantial variations are to be considered within the scope of what is contemplated here. Moreover, if plural examples are given for specific means, or steps, and extrapolation between and/or beyond such given examples is obvious in view of the present disclosure, then the disclosure is to be deemed as effectively disclosing and thus covering at least such extrapolations.

### Reservation of Extra-patent Rights and Interpretation of Terms

After this disclosure is lawfully published, the owner of the present patent application has no objection to the reproduction by others of textual and graphic materials contained herein provided such reproduction is for the limited purpose of understanding the present disclosure of invention and of thereby promoting the useful arts and sciences. The owner does not however disclaim any other rights that may be lawfully associated with the disclosed materials, including but not limited to, copyrights in any computer program listings or art works or other works provided herein, and to trademark or trade dress rights that may be associated with coined terms or art works provided herein and to other otherwise-protectable subject matter included herein or otherwise derivable herefrom.

Unless expressly stated otherwise herein, ordinary terms have their corresponding ordinary meanings within the respective contexts of their presentations, and ordinary terms of art have their corresponding regular meanings within the relevant technical arts and within the respective contexts of their presentations herein.

Given the above disclosure of general concepts and specific embodiments, the scope of protection sought is to be defined by the claims appended hereto. The issued claims are not to be taken as limiting Applicant's right to claim disclosed, but not yet literally claimed subject matter by way of one or more further applications including those filed pursuant to 35 U.S.C. §120 and/or 35 U.S.C. §251.

I claim:

1. A computerized method for automatically generating documents, comprising:
maintaining a database of cases including Identifying information uniquely associated with each case, and further including other information associated with each case;
selecting a case from the database according to case identifying information;
selecting a one or more templates from a list of templates, the one or more selected templates defining information required for a one or more documents associated with the selected case;
retrieving information corresponding to the selected case from the database, said information selected from the database in accordance with the one or more selected templates;
determining that all information for at least one of the one or more of the documents associated with the selected case is available;
generating each document associated with the selected case for which all information is available, wherein said document has not been generated.

2. The method of claim 1, further comprising selecting a formatting template for formatting the document and generating the document in accordance with the selected formatting template.

3. The method according to claim 1, wherein the generated document is printed on paper by controlling a printer.

4. The method according to claim 1, wherein the generated document is stored as an electronic file.

5. The method according to claim 4 wherein the electronic file is stored in a compressed data file format.

6. The method according to claim 4 wherein the electronic file is stored in a PDF file format.

7. The method according to claim 4 wherein the electronic file is stored in a CSV file format.

8. The method according to claim 4 wherein the electronic file is stored in a spreadsheet file format.

9. The method according to claim 4 wherein the electronic file is stored in a word processing file format.

10. The method according to claim 4, wherein the stored electronic file is stored in an image file format.

11. The method according to claim 10, wherein the image file format is that of a PDF file.

12. The method according to claim 10, wherein the image file format is that of a JPEG file.

13. The method according to claim 10, wherein the image file format is that of a GIF file.

14. A computerized method for automatically distributing documents, comprising:
maintaining a database of cases including identifying information uniquely associated with each case, and further including a list of one or more documents associated with each case in the database, a list of one or more recipients for each of the one or more documents, contact information associated with each of the one or more recipients, and a one or more method of distribution associated with each of the one or more recipients;
selecting a case from the database according to identifying information;
distributing each of the one or more documents associated with the selected case to each recipient associated with each of the documents, according to the contact information and distribution method associated with said recipient, wherein any of said documents has not been distributed.

15. The method according to claim 14, wherein the contact information associated with a recipient is an email address.

16. The method according to claim 14, wherein the contact information associated with a recipient is a physical delivery address.

17. The method according to claim 14, wherein the contact information associated with a recipient is a fax number.

18. The method according to claim 14, wherein the contact information associated with a recipient includes a name.

19. The method according to claim 14, wherein the distribution method is sending an email message.

20. The method according to claim 14, wherein the distribution method is sending an email message with an attached electronic file version of a generated document.

21. The method according to claim 14, wherein the distribution method is sending a facsimile image to a facsimile receiver.

22. The method according to claim 14, wherein the distribution method is sending a physical document via a postal service.

23. The method according to claim 14, wherein the distribution method is sending a physical document via an express delivery service.

24. The method according to claim 14 wherein the distribution method is a plurality of distribution methods.

25. A system for automatically generating documents, comprising:
a storage device; and
a processor configured to:
maintain in the storage device a database of cases including identifying information uniquely associated with each case, and further including other information associated with each case;
select a case from the database according to case identifying information;
select a one or more templates from a list of templates, the one or more selected templates defining information required for a one or more documents associated with the selected case;
retrieve information corresponding to the selected case from the database, said information selected from the database in accordance with the one or more selected templates;
determine that all information for one or more of the documents associated with the selected case is available;
generate each document associated with the selected case for which all information is available, wherein said document has not been generated.

26. The system according to claim 25, wherein the processor is further configured to store a generated document in the storage device.

27. The system according to claim 25, wherein the storage device is a hard drive.

28. The system according to claim 25, wherein the storage device is a writeable optical disc.

29. The system according to claim 25, wherein the storage device is a file server.

29. The system according to claim 25, wherein the storage device is an internet-accessible device.

30. The system according to claim 25, wherein the storage device is an electronic memory device.

31. The system according to claim 25, further including a printer operatively in communication with the processor wherein the processor is configured to control the printer to print a version of a generated document.

32. A system for automatically distributing documents, comprising:
a storage device;
means for distributing a document;
a processor configured to:
maintain in the storage device a database of cases including identifying information uniquely associated with each case, and further including a list of one or more documents associated with each case in the database, a list of one or more recipients for each of the one or more documents, contact information associated with each of the one or more recipients, and a one or more method of distribution associated with each of the one or more recipients;
select a case from the database according to identifying information;
distribute each of the one or more documents associated with the selected case to each recipient associated with each of the documents, according to the contact information and distribution method associated with said recipient, wherein any of said documents has not been distributed.

33. The system according to claim 32, wherein the means for distribution includes a modem operatively connected with a telephone system, wherein the processor is configured to control the modem to send a message via the telephone system.

34. The system according to claim 32, wherein the means for distribution includes a network interface card operatively connected with a network wherein the processor is configured to control the network interface card to send a message via the network.

35. The system according to claim 32, wherein the means for distribution includes a facsimile device operatively in communication with a telephone system, wherein the processor is configured to control the facsimile device to send a facsimile document via the telephone system.

36. The system according to claim 32, wherein the means for distribution includes a printer operatively in communication with the processor wherein the processor is configured to control the printer to print a document.

36. A computer-readable medium having computer-executable instructions for performing a method, comprising:
maintaining a database of cases including identifying information uniquely associated with each case, and further including other information associated with each case;
selecting a case from the database according to case identifying information;
selecting a one or more templates from a list of templates, the one or more selected templates defining information required for a one or more documents associated with the selected case;
retrieving information corresponding to the selected case from the database, said information selected from the database in accordance with the one or more selected templates;
determining that all information for at least one of the one or more of the documents associated with the selected case is available;
generating each document associated with the selected case for which all information is available, wherein said document has not been generated.
